(19) United States
(12) Patent Application Publication
(10) Pub. No.: US 2025/0219783 A1
(43) Pub. Date: Jul. 3, 2025

(54) AGGREGATED UPLINK POSITIONING SIGNAL CONFIGURATIONS

(71) Applicant: QUALCOMM Incorporated, San Diego, CA (US)

(72) Inventors: Srinivas YERRAMALLI, San Diego, CA (US); Alexandros MANOLAKOS, Athens (GR); Mukesh KUMAR, Hyderabad (IN)

(21) Appl. No.: 18/848,872

(22) PCT Filed: May 2, 2023
(86) PCT No.: PCT/US2023/020743

§ 371 Date: Sep. 19, 2024

(30) Foreign Application Priority Data
May 24, 2022 (GR) 20220100430

(51) Int. Cl. H04L 5/00; H04W 64/00; H04W 72/231

(52) U.S. Cl. CPC H04L 5/0051; H04L 5/0053; H04W 64/006; H04W 72/231

(57) ABSTRACT

A user equipment (UE) may receive a configuration for a positioning signal transmission from a network entity. The configuration may include a first indication of a cell group associated with a set of positioning signals or a second indication of at least one transmission gap associated with the set of positioning signals. The cell group may include a plurality of cells. The at least one transmission gap may correspond with at least one transmission period of the set of positioning signals. The UE may transmit the positioning signal transmission based on at least one of the cell group or the at least one transmission gap. The positioning signal transmission may include the set of positioning signals. The positioning signal transmission may include a sounding reference signal (SRS) transmission to the cell group. The set of positioning signals may include a set of SRSs.

### CROSS REFERENCE TO RELATED APPLICATION

This application claims the benefit of and priority to Greek patent application Ser. No. 20/220,100430, entitled “AGGREGATED SRS CONFIGURATIONS” and filed on May 24, 2022, which is expressly incorporated by reference herein in its entirety.

### TECHNICAL FIELD

The present disclosure relates generally to communication systems, and more particularly, to a system for configuring uplink positioning signals.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE). The apparatus may receive a configuration for a positioning signal transmission from a network entity. The configuration may include a first indication of a cell group associated with a set of positioning signals or a second indication of at least one transmission gap associated with the set of positioning signals. The cell group may include a plurality of cells. The at least one transmission gap may correspond with at least one transmission period of the set of positioning signals. The apparatus may transmit the positioning signal transmission based on at least one of the cell group or the at least one transmission gap. The positioning signal transmission may include the set of positioning signals.

In an aspect of the disclosure, a method, a computer-readable medium, and an apparatus are provided. The apparatus may include a network node or a network entity. The apparatus may transmit a configuration for a positioning signal transmission to a UE. The configuration may include a first indication of a cell group for a set of positioning signals or a second indication of at least one transmission gap associated with the set of positioning signals. The cell group may include a plurality cells. The at least one transmission gap may correspond with at least one transmission period of the set of positioning signals. The apparatus may receive the positioning signal transmission from the UE based on at least one of the cell group for the set of positioning signals or the at least one transmission gap associated with the set of positioning signals. The positioning signal transmission may include the set of positioning signals.

In an aspect of the disclosure, a method, a computer-readable medium, and an apparatus are provided. The apparatus may have a memory and at least one processor coupled to the memory. Based at least in part on information stored in the memory, the at least one processor may be configured to receive a configuration for a sounding reference signal (SRS) transmission from a network entity. The configuration may include at least one of a cell group for a set of SRSs or at least one transmission gap associated with the set of SRSs. The cell group may include a plurality of intra-band contiguous cells or a plurality of intra-band non-contiguous cells. The at least one transmission gap may correspond to a transmission period of the set of SRSs in the cell group. Based at least in part on information stored in the memory, the at least one processor may be further configured to transmit the SRS transmission to the network entity. The SRS transmission may include the set of SRSs. The SRS transmission may be transmitted based on at least one of the cell group for the set of SRSs or the at least one transmission gap associated with the set of SRSs.

In another aspect of the disclosure, a method, a computer-readable medium, and an apparatus are provided. The apparatus may have a memory and at least one processor coupled to the memory. Based at least in part on information stored in the memory, the at least one processor may be configured to output a configuration for an SRS transmission to a UE. The configuration may include at least one of a cell group for a set of SRSs or at least one transmission gap associated with the set of SRSs. The cell group may include a plurality of intra-band contiguous cells or a plurality of intra-band non-contiguous cells. The at least one transmission gap may correspond to a transmission period of the set of SRSs in the cell group. Based at least in part on information stored in the memory, the at least one processor may be further configured to obtain the SRS transmission from the UE. The SRS transmission may include the set of SRSs. The SRS transmission may be obtained based on at least one of the cell group for the set of SRSs or the at least one transmission gap associated with the set of SRSs.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of positioning based on positioning signal measurements.

FIG. 5A is a diagram illustrating an example of an intra-band non-contiguous aspect.

FIG. 5B is a diagram illustrating an example of an intra-band contiguous aspect.

FIG. 6 is a diagram showing a UE configured to communicate with a network having a first cell and a second cell.

FIG. 7 is a connection flow diagram illustrating an example of a network entity that configures an aggregated SRS transmission and a UE that transmits the configured aggregated SRS transmission.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is a diagram illustrating an example of a hardware implementation for an example network entity.

FIG. 15 is a diagram illustrating an example of a hardware implementation for an example network entity.

### DETAILED DESCRIPTION

A user equipment (UE) may be configured to transmit a set of positioning signals to one or more network nodes or network entities. For example, the UE may transmit a set of sounding reference signals (SRSs) to a set of transmission reception points (TRPs) of a network. The network may measure the received positioning signals for a variety of tasks, for example to calculate a position of the UE, or to estimate an uplink (UL) channel quality over a bandwidth part (BWP). A network entity may configure a positioning signal for each BWP associated with each cell of a wireless network, for example a first positioning signal for each BWP associated with a primary cell and a second positioning signal for each BWP associated with a secondary cell. While the UE may transmit a first positioning signal for a primary cell and a second positioning signal for a secondary cell, both the first and second positioning signals may be similar with respect to one another. Moreover, the UE may be configured to have a gap between transmitting the first positioning signal and transmitting the second positioning signal. The UE may save time and resources by transmitting a single positioning signal for a plurality of cells (i.e., a single SRS that spans multiple cells).

Instead of configuring a positioning signal for each BWP associated with each cell, a network entity may configure a positioning signal transmission to be associated with a frequency band that spans multiple cells. The network entity may define a transmission gap for the positioning signal to enable the UE to transmit the positioning signal transmission for the multiple cells as an intra-band contiguous signal. Before transmitting the positioning signal transmission, the UE may stop transmission on each of the cells, enter a transmission gap mode, and transmit the positioning signal transmission across a larger bandwidth that spans multiple cells.

Various aspects relate generally to bandwidth aggregation. Some aspects more specifically relate to bandwidth aggregation for positioning signals, for example positioning reference signals (PRSs), sounding reference signals (SRSs), or channel state information (CSI) reference signals (CSI-RSs). In some examples, a UE may receive a configuration for a positioning signal transmission from a network entity. The configuration may include a first indication of a cell group associated with a set of positioning signals or a second indication of at least one transmission gap associated with the set of positioning signals. The cell group may include a plurality of cells. The at least one transmission gap may correspond with at least one transmission period of the set of positioning signals. The UE may transmit the positioning signal transmission based on at least one of the cell group or the at least one transmission gap. The positioning signal transmission may include the set of positioning signals.

In some examples, a network entity may transmit a configuration for a positioning signal transmission to a UE. The configuration may include a first indication of a cell group for a set of positioning signals or a second indication of at least one transmission gap associated with the set of positioning signals. The cell group may include a plurality cells. The at least one transmission gap may correspond with at least one transmission period of the set of positioning signals. The network entity may receive the positioning signal transmission from the UE based on at least one of the cell group for the set of positioning signals or the at least one transmission gap associated with the set of positioning signals. The positioning signal transmission may include the set of positioning signals.

In some examples, a network entity may output a configuration for a SRS transmission to a UE. The configuration may include at least one of a cell group for a set of SRSs or at least one transmission gap associated with the set of SRSs. The cell group may include a plurality of intra-band contiguous cells or a plurality of intra-band non-contiguous cells. The at least one transmission gap may correspond to a transmission period of the set of SRSs in the cell group.

The UE may receive a configuration for an SRS transmission from a network entity. The configuration may include at least one of a cell group for a set of SRSs or at least one transmission gap associated with the set of SRSs. The cell group may include a plurality of intra-band contiguous cells or a plurality of intra-band non-contiguous cells. The at least one transmission gap may correspond to a transmission period of the set of SRSs in the cell group.

The UE may transmit the SRS transmission to the network entity. The SRS transmission may include the set of SRSs. The SRS transmission may be transmitted based on at least one of the cell group for the set of SRSs or the at least one transmission gap associated with the set of SRSs.

The network entity may obtain the SRS transmission from the UE. The SRS transmission may include the set of SRSs. The SRS transmission may be obtained based on at least one of the cell group for the set of SRSs or the at least one transmission gap associated with the set of SRSs.

Particular aspects of the subject matter described in this disclosure may be implemented to realize one or more of the following potential advantages. In some examples, by configuring a positioning signal transmission associated with at least one of a cell group associated with a set of positioning signals or a transmission gap associated with the set of positioning signals, the positioning signal transmission may be transmitted to a cell group instead of to one cell at a time. From the UE perspective, the positioning signal transmission may span multiple cells that have no frequency gap between the cells. From the network node (i.e., transmission reception point (TRP)) perspective, the positioning signal transmission may be a contiguous reception of a set of positioning signals across a large bandwidth across a plurality of cells in the cell group. This reduces the amount of resources used for transmission of positioning signals to a plurality of cells in a cell group as well as the amount of resources used for configuration of the positioning signal transmission.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

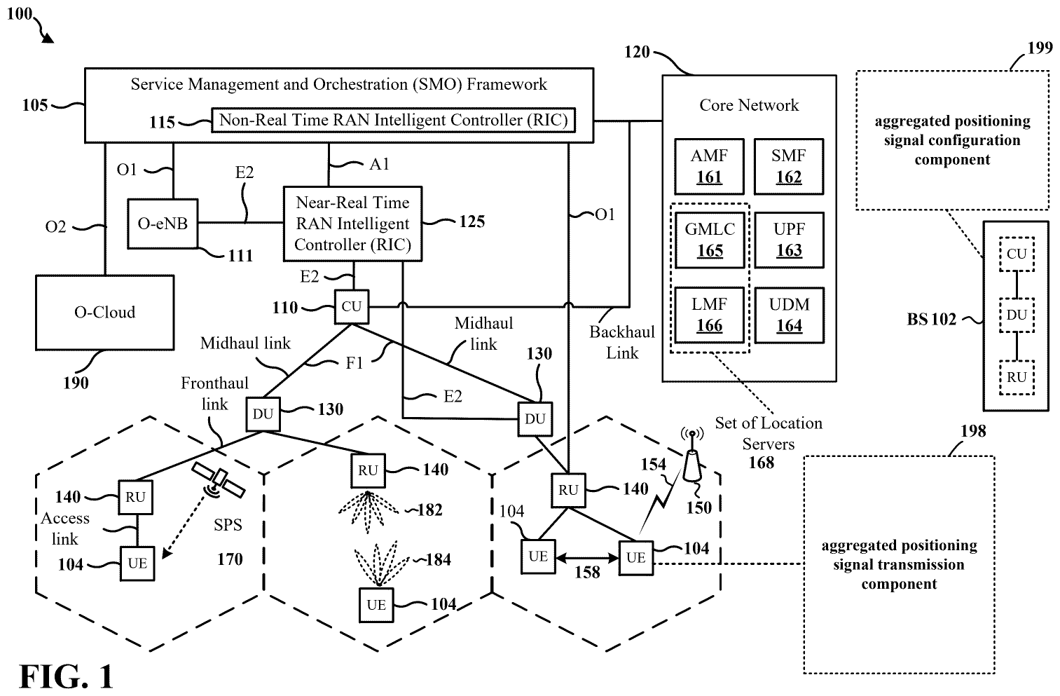

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an Al interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as Al policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 500, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 902.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (510 MHz-7.125 GHZ) and FR2 (24.25 GHz-52.6 GHz). Although a portion of FRI is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an aggregated positioning signal transmission component 198 that may be configured to receive a configuration for an SRS transmission from a network entity. The configuration may include at least one of a cell group for a set of SRSs or at least one transmission gap associated with the set of SRSs. The cell group may include a plurality of intra-band contiguous cells or a plurality of intra-band non-contiguous cells. The at least one transmission gap may correspond to a transmission period of the set of SRSs in the cell group. The aggregated positioning signal transmission component 198 may also be configured to transmit the SRS transmission to the network entity. The SRS transmission may include the set of SRSs. The SRS transmission may be transmitted based on at least one of the cell group for the set of SRSs or the at least one transmission gap associated with the set of SRSs.

In certain aspects, the base station 102 may include an aggregated positioning signal configuration component 199 that may be configured to output a configuration for an SRS transmission to a UE. The configuration may include at least one of a cell group for a set of SRSs or at least one transmission gap associated with the set of SRSs. The cell group may include a plurality of intra-band contiguous cells or a plurality of intra-band non-contiguous cells. The at least one transmission gap may correspond to a transmission period of the set of SRSs in the cell group. The aggregated positioning signal configuration component 199 may also be configured to obtain the SRS transmission from the UE. The SRS transmission may include the set of SRSs. The SRS transmission may be obtained based on at least one of the cell group for the set of SRSs or the at least one transmission gap associated with the set of SRSs. Although the following description may be focused on 5G NR, the concepts described herein may be applicable to other similar areas, such as LTE, LTE-A, CDMA, GSM, and other wireless technologies.

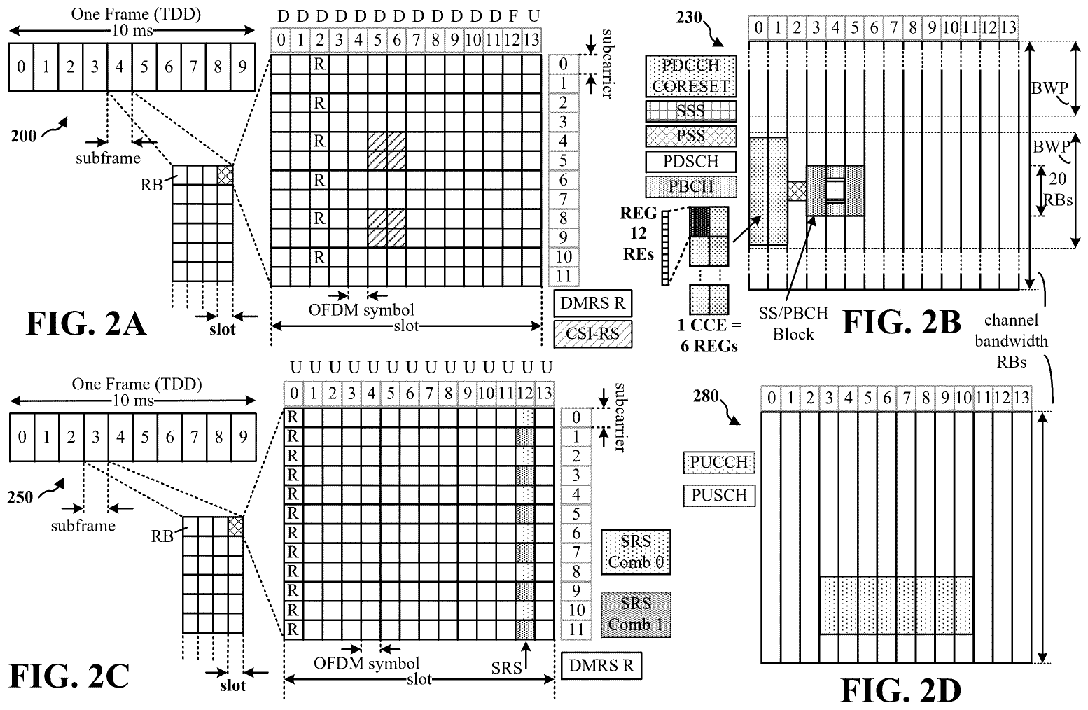

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1(with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ u 0 to 4 allow for 1, 2, 4, 8,and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ} * 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRSs). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

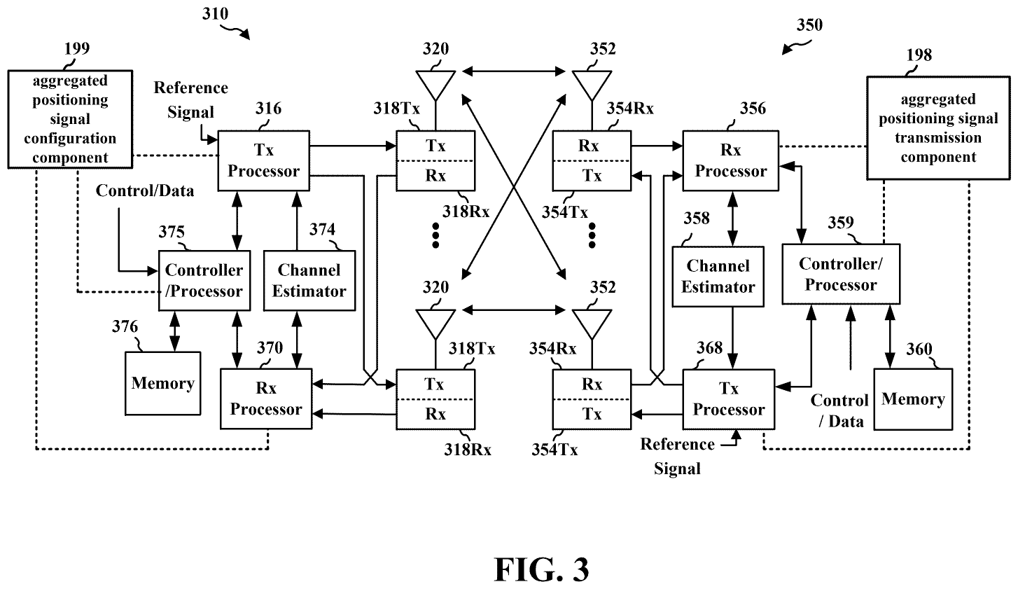

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the aggregated positioning signal transmission component 198 of FIG. 1.

At least one of the Tx processor 316, the Rx processor 370, and the controller/processor 375 may be configured to perform aspects in connection with the aggregated positioning signal configuration component 199 of FIG. 1.

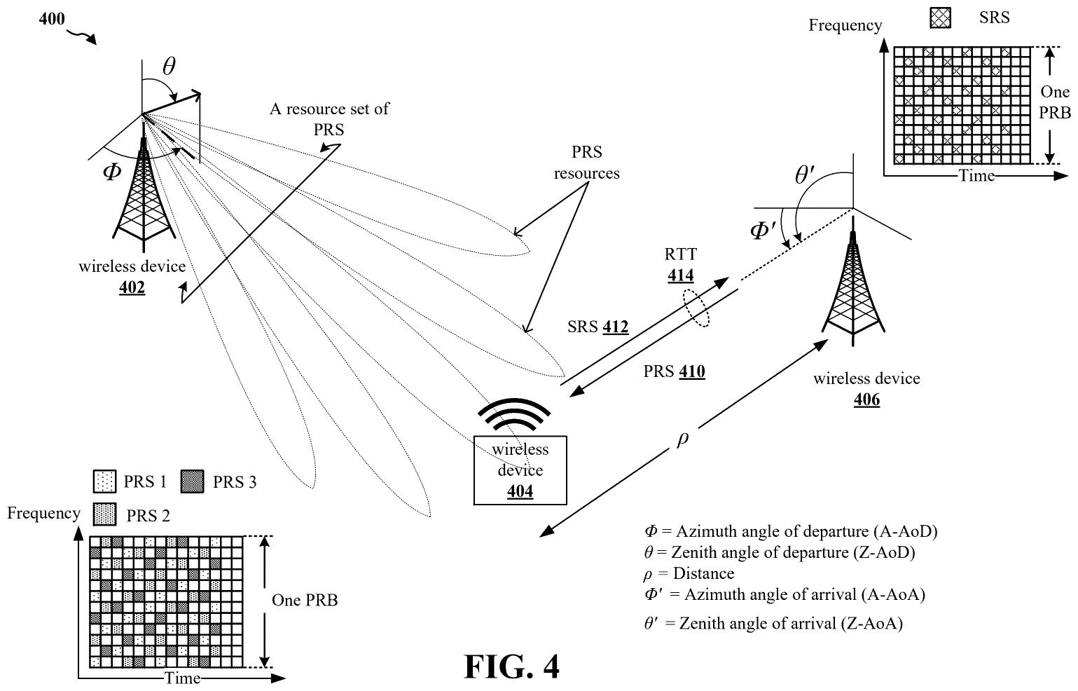

FIG. 4 is a diagram 400 illustrating an example of positioning based on reference signal measurements. The wireless device 402 may be a UE, a base station, or a positioning reference unit (PRU). The wireless device 404 may be a UE, a base station, or a PRU. The wireless device 406 may be a UE, a base station, or a PRU. The wireless device 402 may be referred to as a positioning target wireless device, whose location may be calculated based on measurements of one or more reference signals. The wireless device 404 and the wireless device 406 may be referred to as positioning neighbor wireless devices, whose locations may be known, which may be used to calculate the location of the wireless device 402. The wireless device 404 may transmit SRS 412 at time T_{SRS_TX} to the wireless device 406. The wireless device 404 may receive positioning reference signals (PRS) 410 at time T_{PRS_RX} from the wireless device 406. The SRS 412 may be an UL-SRS. The PRS 410 may be a DL-PRS. In some aspects, the wireless device 402 may be a TRP and the wireless device 406 may be a TRP, which may be both configured to transmit DL-PRS to the wireless device 404. The wireless device 404 may be a UE configured to transmit UL-SRS to the wireless device 402 and the wireless device 406.

The wireless device 406 may receive the SRS 412 at time T_{SRS_RX} from the wireless device 404 and transmit the PRS 410 at time T_{PRS_TX} to the wireless device 404. The wireless device 404 may receive the PRS 410 before transmitting the SRS 412. The wireless device 404 may transmit the SRS 412 before receiving the PRS 410. The wireless device 404 may transmit the SRS 412 in response to receiving the PRS 410. The wireless device 406 may transmit the PRS 410 in response to receiving the SRS 412. A positioning server (e.g., location server(s) 168), the wireless device 404, or the wireless device 406 may determine the round-trip-time (RTT) 414 based on ∥T_{SRS_RX}-T_{PRS_TX}|-|T_{SRS_TX}-T_{PRS_RX}∥. Multi-RTT positioning may make use of the Rx-Tx time difference measurements (i.e., |T_{SRS_TX}-T_{PRS_RX}|) and PRS reference signal received power (RSRP) (PRS-RSRP) of PRS signals received from multiple wireless devices, such as the wireless device 402 and the wireless device 406, which are measured by the wireless device 404, and the measured Rx-Tx time difference measurements (i.e., |T_{SRS_RX}-T_{PRS_TX}|) and SRS-RSRP at multiple wireless devices, such as at the wireless device 402 and at the wireless device 406 of SRS transmitted from wireless device 404. The wireless device 404 may measure the Rx-Tx time difference measurements, and/or PRS-RSRP of the received signals, using assistance data received from the positioning server, the wireless device 402, and/or the wireless device 406. The wireless device 402 and the wireless device 406 may measure the Rx-Tx time difference measurements, and/or SRS-RSRP of the received signals, using assistance data received from the positioning server. The measurements may be used at the positioning server or the wireless device 404 to determine the RTT, which may be used to estimate the location of the wireless device 404. Other methods are possible for determining the RTT, such as for example using time-difference of arrival (TDOA) measurements, such as DL-TDOA and/or UL-TDOA measurements.

DL-AoD positioning may make use of the measured PRS-RSRP of signals transmitted from multiple wireless devices, such as the wireless device 402 and the wireless device 406, and received at the wireless device 404. The AoD positioning may also be referred to as DL-AoD positioning where the PRS are DL signals. The wireless device 404 may measure the PRS-RSRP of the received signals using assistance data received from the positioning server, and the resulting measurements may be used along with the azimuth angle of departure (A-AoD), the zenith angle of departure (Z-AoD), and other configuration information to locate the wireless device 404 in relation to the neighboring wireless devices that transmitted the PRS, such as the wireless device 402 and the wireless device 406.

DL-TDOA positioning may make use of the DL reference signal time difference (RSTD), and/or PRS-RSRP of signals received from multiple wireless devices, such as the wireless device 402 and the wireless device 406, at the wireless device 404. The wireless device 404 may measure the RSTD, and/or the PRS-RSRP, of the received PRS signals using assistance data received from the positioning server, and the resulting measurements may be used along with other configuration information to locate the wireless device 404 in relation to the neighboring wireless devices that transmitted the PRS, such as the wireless device 402 and the wireless device 406.

UL-TDOA positioning may make use of the UL relative time of arrival (RTOA), and/or SRS-RSRP, at multiple wireless devices, such as the wireless device 402 and the wireless device 406, of signals transmitted from the wireless device 404. The wireless devices, such as the wireless device 402 and the wireless device 406, may measure the RTOA, and/or the SRS-RSRP, of the received signals using assistance data received from the positioning server, and the resulting measurements may be used along with other configuration information to estimate the location of the wireless device 404.

UL-AoA positioning may make use of the measured azimuth angle of arrival (A-AoA) and zenith angle of arrival (Z-AoA) at multiple wireless devices, such as the wireless device 402 and the wireless device 406, of signals transmitted from the wireless device 404. The wireless device 402 and the wireless device 406 may measure the A-AoA and the Z-AoA of the received signals using assistance data received from the positioning server, and the resulting measurements may be used along with other configuration information to estimate the location of the wireless device 404.

Additional positioning methods may be used for estimating the location of the wireless device 404, such as for example, UL-AoD and/or DL-AoA at the wireless device 404. Note that data/measurements from various technologies may be combined in various ways to increase accuracy, to determine and/or to enhance certainty, to supplement/complement measurements, and/or to substitute/provide for missing information.

A UE may be configured to transmit a positioning signal, such as an SRS or a CSI-RS, to a set of network nodes. The positioning signal may be an UL signal, such as an UL-SRS. One or more of the network nodes that receive the positioning signal may use the positioning signal to estimate an uplink channel quality over a bandwidth part (BWP) (i.e., a frequency band), for example effects of multipath fading, scattering, Doppler and power loss of a transmitted uplink signal. The network may use this information for resource scheduling, beam management, and power control of a signal using that BWP. A network entity, such as an LMF, may perform positioning based on measurements of the positioning signal. For example, a network entity may calculate an RTOA of a positioning signal transmitted from the UE to a plurality of network nodes to calculate a position of the UE.

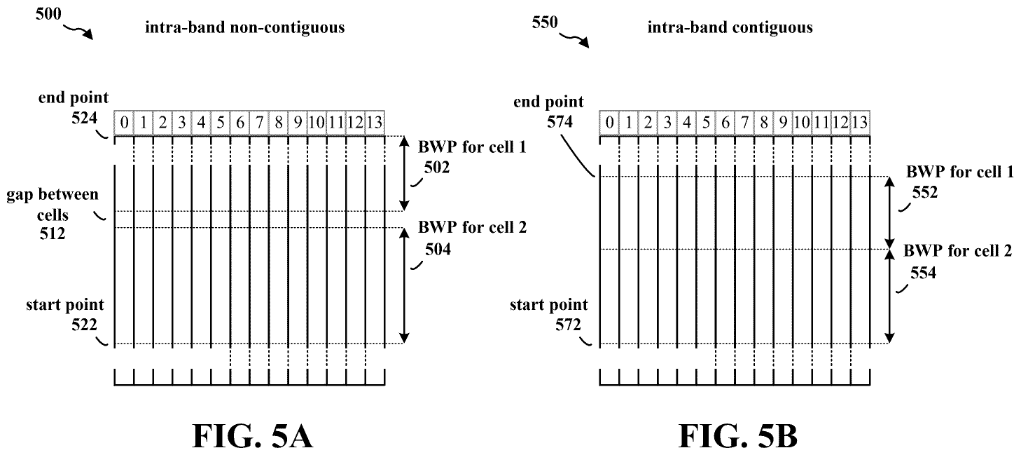

A network may allocate a BWP for each cell associated with a UE, for example a first BWP for a primary cell, a second BWP for a secondary cell, and so on. The BWPs may or may not be contiguous. For example, FIG. 5A is a diagram 500 illustrating an example of an intra-band non-contiguous case with a BWP 502 for cell 1 and a BWP 504 for cell 2. The BWP 502 and the BWP 504 may have a gap 512 between the cells for radio frequency (RF) considerations (e.g., minimize possible interference between cell 1 and cell 2. The BWP 502 and the BWP 504 may also be described as a BWP for both cell 1 and cell 2 having a start point 522, an end point 524, and a gap 512 between the cells 1 and 2. While diagram 500 illustrates an example of an intra-band non-contiguous case with a gap 512 in a frequency domain, the BWP 502 and the BWP 504 may be transmitted with a gap in a time domain. In such an aspect, a UE may transmit a first set of positioning signals using a first BWP, followed by a gap, then followed by transmitting a second set of positioning signals using a second BWP.

FIG. 5B is a diagram 550 illustrating an example of an intra-band contiguous case with a BWP 552 for cell 1 and a BWP 554 for cell 2. The BWP 552 and the BWP 554 may not have a gap between cell 1 and cell 2, or the gap may be so small such that, from a TRP perspective, BWP 552 and BWP 554 may appear to be a contiguous reception across a large bandwidth across cells. The BWP 552 and the BWP 554 may also be described as a BWP for both cell 1 and cell 2having a start point 572 and an end point 574.

In some aspects, each BWP may correspond with a discrete positioning signal configuration. For example, each cell may correspond with a network node that independently configures a positioning signal configuration for a transmission of a positioning signal from a UE to a set of network nodes via a dedicated BWP. In some aspects, a network may configure a group of cells with a BWP, where each portion of the BWP corresponds with a discrete cell. The network may configure a UE to have a transmission gap used for the UE to transmit a positioning signal across a bandwidth that spans multiple cells. During the transmission gap, the UE may be configured to stop monitoring the ells, and transmit the positioning signal across the cells.

A network entity may configure a set of positioning signals to be transmitted for each BWP associated with a cell, for example a first SRS for a primary cell and a second SRS for a secondary cell. While the UE may transmit a first SRS for a primary cell and a second SRS for a secondary cell, both the first and second SRSs may be similar with respect to one another. While a UE may be configured to transmit a set of SRS simultaneously across multiple cells (e.g., a first SRS using BWP 552 for cell 1 and a second SRS using BWP 554 for cell 2 in FIG. 5B), the UE may save time and resources by transmitting a single SRS that spans multiple cells (e.g., a single SRS spanning both the BWP 552 for cell 1 and the BWP 554 for cell 2 in FIG. 5B). In other words, from the UE perspective, the UE may transmit a positioning signal that spans multiple cells which have no frequency gap between them. A network entity may define a positioning signal configuration for a positioning signal transmission associated with a frequency band that spans multiple cells. The network entity may define a transmission gap for the positioning signal to enable the UE to transmit the positioning signal transmission. In other words, before transmitting the positioning signal transmission, the UE may stop transmission on each of the cells, go into transmission gap mode, and then transmit the positioning signal transmission across a larger bandwidth that spans multiple cells.

In one aspect, a UE may receive a configuration for a positioning signal transmission from a network entity. The configuration may include a first indication of a cell group associated with a set of positioning signals or a second indication of at least one transmission gap associated with the set of positioning signals. The cell group may include a plurality of cells. The at least one transmission gap may correspond with at least one transmission period of the set of positioning signals. The UE may transmit the positioning signal transmission based on at least one of the cell group or the at least one transmission gap. The positioning signal transmission may include the set of positioning signals.

In one aspect, a network entity may transmit a configuration for a positioning signal transmission to a UE. The configuration may include a first indication of a cell group for a set of positioning signals or a second indication of at least one transmission gap associated with the set of positioning signals. The cell group may include a plurality cells. The at least one transmission gap may correspond with at least one transmission period of the set of positioning signals. The network entity may receive the positioning signal transmission from the UE based on at least one of the cell group for the set of positioning signals or the at least one transmission gap associated with the set of positioning signals. The positioning signal transmission may include the set of positioning signals.

In one aspect, a network entity may output a configuration for an SRS transmission to a UE. The configuration may include at least one of a cell group for a set of SRSs or at least one transmission gap associated with the set of SRSs. The cell group may include a plurality of intra-band contiguous cells or a plurality of intra-band non-contiguous cells. The at least one transmission gap may correspond to a transmission period of the set of SRSs in the cell group.

The UE may receive a configuration for an SRS transmission from a network entity. The configuration may include at least one of a cell group for a set of SRSs or at least one transmission gap associated with the set of SRSs. The cell group may include a plurality of intra-band contiguous cells or a plurality of intra-band non-contiguous cells. The at least one transmission gap may correspond to a transmission period of the set of SRSs in the cell group.

The UE may transmit the SRS transmission to the network entity. The SRS transmission may include the set of SRSs. The SRS transmission may be transmitted based on at least one of the cell group for the set of SRSs or the at least one transmission gap associated with the set of SRSs.

The network entity may obtain the SRS transmission from the UE. The SRS transmission may include the set of SRSs. The SRS transmission may be obtained based on at least one of the cell group for the set of SRSs or the at least one transmission gap associated with the set of SRSs.

In some aspects, a UE may define a plurality of BWPs in a time domain, and then combine the plurality of BWPs in a frequency domain. For example, a UE may define a first BWP using a 4K fast Fourier transform (FFT) that may map to a 100 MHz bandwidth at a 30 kHz carrier spacing, and a second BWP using a 4K FFT that may map to a 100 MHz bandwidth at a 30 kHz carrier spacing. The UE may then combine the plurality of BWPs to transmit an 8K FFT, aggregating two different cells together without a gap in between the cells. The receiving network nodes may then separate the received signal such that a first receiving cell processes a first portion of the positioning signal and a second receiving cell processes a second portion of the positioning signal.

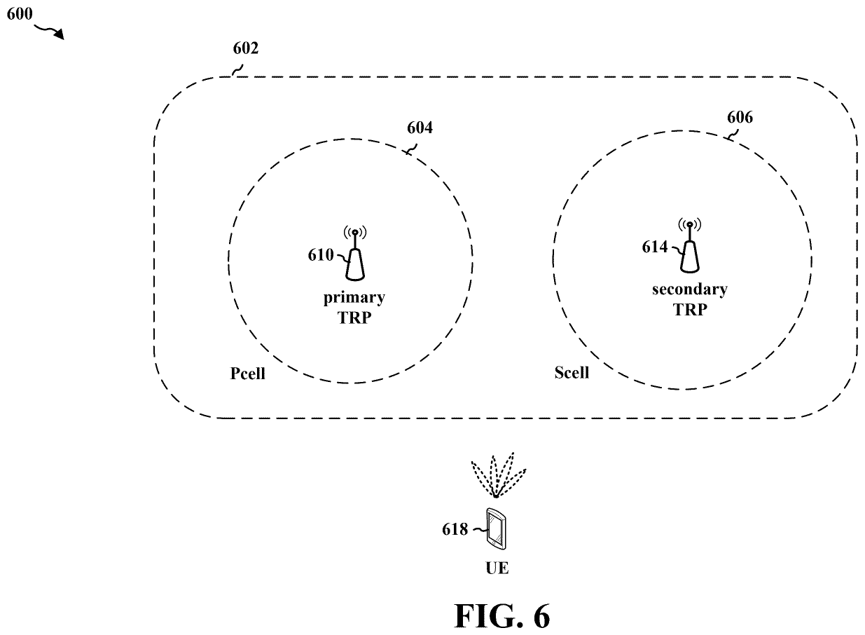

FIG. 6 shows a diagram 600 having a UE 618 configured to communicate with a network having a primary TRP 610 in a primary cell 604 and a secondary TRP 614 in a secondary cell 606. The primary cell 604 and the secondary cell 606 may be grouped together in a cell group 602. The primary cell 604 and the secondary cell 606 may each be designated as part of the same quasi-co-located (QCL) cell group 602 such that the UE 618 may be able to transmit a signal that may be received by either the primary TRP 610 in the primary cell 604 or the secondary TRP 614 in the secondary cell 606. Each of the primary TRP 610 and the secondary TRP 614, may be controlled and operated by a single network entity, a plurality of network entities (multiple network entities controlling one TRP), or by different network entities (each network entity controlling a different TRP) in network communication with one another, such as via backhaul connection. Each of the primary TRP 610 and the secondary TRP 614 may be active simultaneously, providing maximum throughput in times of a high load. While the cell group 602 is shown having only two cells, a primary cell 604 and a secondary cell 606, the cell group 602 may have more cells in other aspects. For example, the cell group 602 may have a plurality of secondary cells in addition to the primary cell.

A network entity, such as a location management function (LMF), a core network, or one of the primary TRP 610 or the secondary TRP 614, may configure the primary cell 604 to have a first BWP and the secondary cell 606 to have a second BWP, similar to the BWP 502 and the BWP 504 in FIG. 5A, respectively, or to the BWP 552 and the BWP 554 in FIG. 5B, respectively. In other words, a network entity may configure the primary cell 604 and the secondary cell 606 to have intra-band, non-contiguous BWPs or to have intra-band, contiguous BWPs.

In some aspects, each of the primary cell 604 and the secondary cell 606 may have discrete configuration parameters (e.g., definitions, references), such as an SSB index, a DL-PRS, an UL-SRS, a CSI-RS resource identifier, a BWP identifier (e.g., a set of RBs for the BWP associated with the cell), a resource identifier for an SRS, or a resource position identifier for an SRS. In some aspects, a network entity may configure the UE 618 to transmit a set of positioning signals to the cell group 602 in a single configuration, for the primary TRP 610 to receive and process a first BWP of the set of positioning signals that it receives from the UE 618, and for the secondary TRP 614 to receives and process a second BWP, different from the first BWP, of the set of positioning signals that it receives from the UE 618. In other words, from the perspective of the UE 618, the set of positioning signals may span multiple cells that don't have a frequency gap between the BWPs of each cell. From the perspective of the primary TRP 610, the set of positioning signals may be a contiguous reception of a portion of a BWP across a large BW across cell group 602. From the perspective of the secondary TRP 614, the set of positioning signals may be a contiguous reception of a different portion of a BWP across a large BW across cell group 602. In some aspects, a network entity may define a configuration for the UE 618 to transmit a set of positioning signals to the cell group 602, spanning multiple cells. In some aspects, a network entity may define a transmission gap for the UE 618 to transmit a set of positioning signals to the cell group 602. During the transmission gap, all of the cells of the cell group 602 may be configured to not transmit or receive Uu signals (e.g., PUSCH, PUCCH, PDSCH, PDCCH) such that the cells of the cell group 602 may receive the set of positioning signals from the UE 618. In other words, during a transmission gap, the UE 618 may stop monitoring the cells of the cell group 602 and may transmit the set of positioning signals to the cell group 602.

While diagram 600 illustrates a UE 618 transmitting a set of positioning signals to the cell group 602 having two cells (primary cell 604 and secondary cell 606), the UE 618 may be configured to transmit a set of positioning signals to a cell group having any number of cells, for example three or four cells, each having a different BWP of the set of positioning signals.

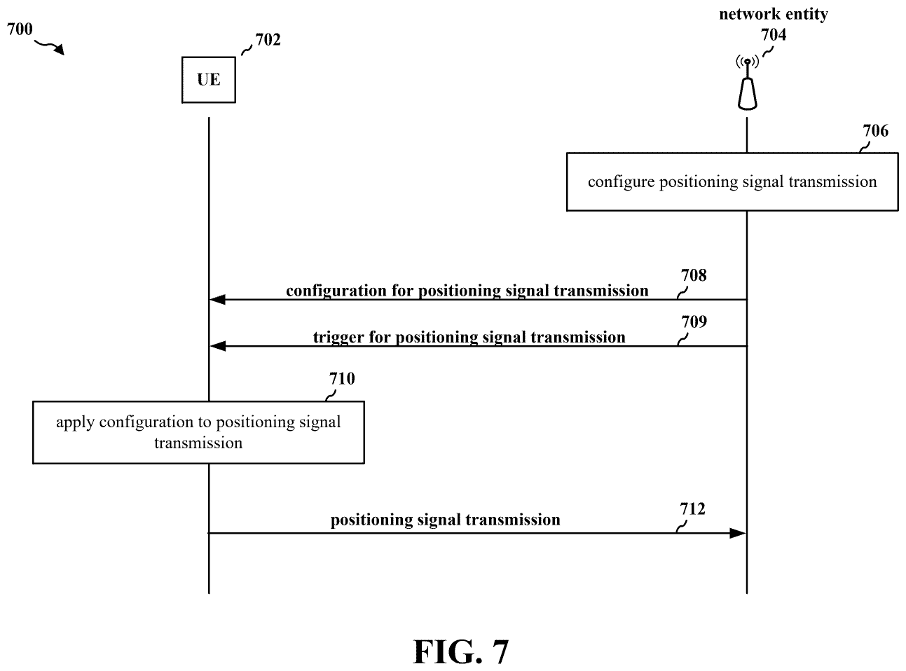

FIG. 7 shows a connection flow diagram 700 illustrating an example of a network entity 704 that configures an aggregated positioning signal transmission and a UE 702 that transmits the configured aggregated positioning signal transmission. The network entity 704 may be an entity that configures a positioning session for a plurality of cells, for example a core network or a location management function (LMF), or may be a network node that serves the UE 702, for example a TRP of a primary cell of the UE 702, or a TRP of a secondary cell of the UE 702.

At 706 the network entity 704 may configure the positioning signal transmission. The positioning signal transmission may include a set of positioning signals, such as an SRS or a CSI-RS transmitted by the UE 702 at a plurality of network nodes, such as a plurality of TRPs. The plurality of network nodes may include a plurality of cells that are associated with a QCL. In one aspect, the network entity 704 may define a positioning signal transmission configuration to span a plurality of cells, such as the primary cell 604 and the secondary cell 606 in FIG. 6. The plurality of cells may be referred to as a cell group. In other words, the network entity 704 may associate the positioning signal transmission with cells of a cell group, such as the cell group 602 in FIG. 6 that includes the primary cell 604 and the secondary cell 606. The positioning signal transmission configuration may include a set of positioning signals, for example an SRS for positioning, an SRS for MIMO, and/or a CSI-RS. In other words, the network entity 704 may associate the positioning signal transmission with a set of positioning signals. In one aspect, the network entity 704 may configure the positioning signal transmission to be transmitted by the UE 702 as a set of positioning signals using the BWPs of each of the cells of the cell group associated with the positioning signal transmission. The network entity 704 may configure the positioning signal transmission independently outside the RRC configuration for each individual cell (e.g., via a MAC-CE or a DCI) or may configure the positioning signal transmission within an RRC configuration.

The definitions for the positioning signal transmission configuration may be closely tied to definitions or configurations in cells associated with the positioning signal transmission. In other words, the positioning signal transmission may have one or more references (e.g., SSB, pathloss reference signal (PL-RS), spatial relationship) that are defined by a reference of one or more cells in the cell group associated with the positioning signal transmission. Such references may be provided in the positioning signal transmission configuration itself, or the positioning signal transmission configuration may have one or more identifiers that define the cells in the cell group associated with the positioning signal transmission, and the UE 702 may retrieve references associated with cells in the cell group using the one or more identifiers. For example, the network entity 704 may define the positioning signal transmission configuration to have references of each cell of a cell group (e.g., a primary cell, secondary cells of a master cell group (MCG) and/or secondary cells of a secondary cell group (SCG)). By providing such a positioning signal transmission configuration to the UE 702, the network entity 704 may enable the UE 702 to utilize configurations of the cells associated with the positioning signal transmission to define parameters of the positioning signal transmission, such as a pathloss reference signal (PL-RS) for the positioning signal transmission or a spatial relationship for the positioning signal transmission.

In one aspect, the positioning signal transmission configuration may define a PL-RS reference for the positioning signal transmission based on a PL-RS reference of a cell in the cell group or based on PL-RS references of a plurality of cells in the cell group. Contemplated PL-RS references include, for example, a synchronization signal block (SSB) index of a cell or a neighboring cell, or a downlink positioning reference signal (DL-PRS). In one aspect, the positioning signal transmission configuration may identify a specific cell in the cell group as being associated with a PL-RS reference for use to calculate the PL-RS reference for the positioning signal transmission. The UE 702 may then base the PL-RS reference for the positioning signal transmission on the identified specific cell in the cell group (e.g., a primary cell in the cell group, or specified secondary cell in the cell group). The positioning signal transmission configuration may identify the specific cell by an identifier of the secondary cell. In another aspect, the positioning signal transmission configuration may base the PL-RS reference for the positioning signal transmission on PL-RS references of a plurality of cells in the cell group. The positioning signal transmission configuration may identify the plurality of cells, for example by providing identifiers of a subset of cells in the cell group, or by indicating to the UE 702 to use references from all of the cells in the cell group to calculate the PL-RS reference for the positioning signal transmission. For example, the positioning signal transmission configuration may define a PL-RS reference of an SSB index for the positioning signal transmission as a sum of the SSB indices for each of the cells in the cell group multiplied by a weight, where the sum of each of the weights adds is 1. The weights may each be equal (i.e., the sum is average of the SSB indices for each of the cells in the cell group) or may not be equal (e.g., a higher weight modifier may be applied to the PL-RS reference of the primary cell and a lower weight modifier may be applied to the PL-RS reference of a secondary cell).

In one aspect, the positioning signal transmission configuration may define a spatial relationship reference for the positioning signal transmission based on a spatial relationship reference of a cell in the cell group or based on spatial relationship references of a plurality of cells in the cell group. Contemplated spatial relationship references include, for example, an SSB index of a cell or a neighboring cell, a PRS (e.g., a DL-PRS), an SRS (e.g., an UL-SRS), a CSI-RS, a resource of an SRS in the set of positioning signals associated with the positioning signal transmission, a resource position of an SRS in the set of positioning signals associated with the positioning signal transmission, or a bandwidth part (BWP). In one aspect, the positioning signal transmission configuration may identify a specific cell in the cell group as being associated with a spatial relationship reference for use to calculate the spatial relationship reference for the positioning signal transmission. The UE 702 may then base the spatial relationship reference for the positioning signal transmission on the identified specific cell in the cell group. The positioning signal transmission configuration may identify the specific cell by an identifier of the secondary cell. In another aspect, the positioning signal transmission configuration may base the spatial relationship reference for the positioning signal transmission on spatial relationship references of a plurality of cells in the cell group. The positioning signal transmission configuration may identify the plurality of cells, for example by providing identifiers of a subset of cells in the cell group, or by indicating to the UE 702 to use references from all of the cells in the cell group to calculate the spatial relationship reference for the positioning signal transmission. For example, the positioning signal transmission configuration may define a spatial relationship reference of a CSI-RS for the positioning signal transmission to be a CSI-RS associated with a majority of the cells in the cell group.

In one aspect, the positioning signal transmission configuration may define a start point of the positioning signal transmission to be with respect to the RBs of a first cell, and may define an end point of the positioning signal transmission to be with respect to the RBs of a second cell. For example, a positioning signal transmission configuration may define a positioning signal transmission for the BWP 502 and BWP 504 in FIG. 5A to have a start point 522 with respect to the RBs of the BWP 504 for cell 2, and have an end point 524 with respect to the RBs of the BWP 502 for cell 1. In another aspect, an SRS transmission configuration may define an SRS transmission for the BWP 552 and BWP 554 in FIG. 5B to have a start point 572 with respect to the RBs of the BWP 554 for cell 2, and have an end point 574 with respect to the RBs of the BWP 552 for cell 1. The network entity 704 and/or the UE 702 may determine that all of the RBs in between the two defined points belong to a cell group, for example the cell group 602 in FIG. 6, and provide an indicator of a BWP defined by the two points to be associated with the positioning signal transmission. The positioning signal transmission configuration may restrict a definition of cells belonging to a cell group for a positioning signal transmission to be cells that are adjacent to one another and in the same band. The configuration 708 may indicate a set of positioning signal resources for each BWP and/or a positioning signal resource for each cell.

The positioning signal transmission configuration may define the positioning signal transmission to be periodic, semi-persistent, or aperiodic. The positioning signal transmission configuration may define the positioning signal transmission to have the same sub-carrier spacing (SCS) as one or more of the cells that the positioning signal transmission is associated with, or may configure the positioning signal transmission to have different sub-carrier spacing (SCS) than an SCS of one or more of the cells that the positioning signal transmission is associated with.

The network entity may output the configuration 708 for the positioning signal transmission to the UE 702. The configuration 708 may be in any suitable format, for example an RRC configuration, a MAC-CE, or a DCI. For example, the configuration 708 for the positioning signal transmission may be an RRC configuration that indicates that the UE 702 periodically transmit the positioning signal transmission across a plurality of cells. The RRC configuration may add positioning signal resources to a cell group (e.g., one resource per cell group) associated with the UE 702 and/or may remote positioning signal resources to a cell group associated with the UE 702. In some aspects, the RRC configuration for a cell group may be configured independently from the configurations of each individual cell of the cell group.

The RRC configuration may configure an RRC active and an RRC inactive state for the UE 702, and may configure the positioning signal transmission to be applicable even when the UE 702 is in an RRC inactive state for enabling inactive mode positioning. For example, the configuration 708 for the positioning signal transmission may include an indication for the UE 702 to enter an RRC inactive state and for the UE 702 to transmit the positioning signal transmission during the RRC inactive state. The configuration 708 may include a plurality of transmissions from the network entity 704 to the UE 702. For example, an RRC configuration from the network entity 704 (or a network node serving the UE 702) to the UE 702 may configure a portion of the positioning signal transmission, and a MAC-CE or a DCI from the network entity 704 (or a network node serving the UE 702) to the UE 702 may trigger an execution of the configured portion of the SRS transmission. In some aspects, the configuration 708 may include an RRC configuration that configures a semi-periodic or an aperiodic positioning signal transmission for the UE 702 to transmit to a cell group, and the trigger 709 may include a MAC-CE or a DCI that triggers execution of the positioning signal transmission. In some aspects, the trigger may include an indicator of a portion of the configuration 708. For example, the configuration 708 may define a set of resources, where each resource is associated with a cell. The trigger 709 may include a set of indicators for cells in a cell group, some of which correspond with a subset of the set of resources. The UE 702 may transmit the positioning signal transmission 712 corresponding with the subset of resources. In one aspect, the configuration 708 may include an RRC configuration for the UE 702 that defines a set of cells, or set of resources, each of which is associated with a cell of a cell group. In some aspects, the RRC configuration may include a configuration for an RRC active state of the UE 702, and a configuration for RRC inactive state of the UE 702. The configuration for an RRC active state of the UE 702 may include an indication of cells in the cell group and an indication of a set of transmission gaps, during which the UE 702 transmits the set of positioning signals at the cells in the cell group. During a transmission gap, the UE 702 may pause active monitoring of cells to transmit the set of positioning signals. The configuration for an RRC inactive state of the UE 702 may include an indication of cells in the cell group.

For a semi-persistent or an aperiodic positioning signal transmission, the configuration 708 may include a MAC-CE or DCI that triggers a transmission of the positioning signal from the UE 702. For example, the configuration 708 may include an indication for the UE 702 to transmit a positioning signal transmission when the UE receives a MAC-CE or DCI from a cell in the cell group to transmit the positioning signal transmission (or any positioning signal). The MAC-CE or DCI may include an indication to transmit the positioning signal transmission. In one aspect, the configuration 708 may identify a cell in the cell group to the UE 702 as a triggering cell, and in response the UE 702 may transmit the positioning signal transmission in response to receiving a MAC-CE or DCI from the identified cell to transmit the SRS transmission. In another aspect, the configuration 708 may identify a plurality of cells in the cell group to the UE 702 as triggering cells, and in response the UE 702 may transmit the positioning signal transmission in response to receiving a MAC-CE or DCI from each of the identified cells to transmit the positioning signal transmission. The plurality of cells may include a subset of the cells in the cell group or all the cells in the cell group.

In some aspects, at least one network node from each cell in a cell group may transmit a configuration 708 to the UE 702 for transmitting a set of positioning signals to the cell group. Each of the configurations may share the same slot, the same symbols, and the same antenna of the UE 702. In some aspects, each of the configurations may share the same start position and the same number of slots. In some aspects, each of the configurations may share the same numerology, for example the same control plane (CP) and/or sub-carrier spacing (SCS). In some aspects, each of the configurations may share the same frequency comb size. The UE 702 may, in response to recognizing these same attributes or characteristics, aggregate the set of positioning signals into a single positioning signal transmission for all cells in the cell group.

At 710 the UE 702 may apply the configuration 708 to the positioning signal transmission. In some aspects, the UE 702 may define the positioning signal transmission in accordance with the configuration 708 provided by the network entity 704. For example, the configuration 708 may identify a cell group to the UE 702, and in response the UE 702 may define a bandwidth of the positioning signal transmission as all the RBs of all BWPs associated with cells of the cell group associated with the positioning signal transmission (e.g., all the RBs between the start point 522 and the end point 524 in FIG. 5A or all the RBs between the start point 572 and the end point 574 in FIG. 5B).

The UE 702 may be configured to derive one or more references based on the positioning signal transmission configuration, such as a PL-RS reference or a spatial relationship reference. In one aspect, the UE 702 may derive a timing of the positioning signal transmission based on the timing of one of the resources of one of the cells in the cell group associated with the positioning signal transmission. In another aspect, the configuration 708 may include an indication for the UE 702 to derive the timing based on one of the positioning signals of the set of positioning signals identified in the configuration 708. In another aspect, the configuration 708 may include an indication for the UE 702 to derive the positioning signal timing based on one of the resources for a specific cell in the cell group identified in the configuration 708. In another aspect, the UE 702 may base the timing for the positioning signal transmission on timing of a plurality of cells in the cell group. The configuration 708 may identify the plurality of cells, for example by providing identifiers of a subset of cells in the cell group, or by indicating to the UE 702 to use references from all of the cells in the cell group to calculate the timing for the positioning signal transmission. For example, the configuration 708 may define a timing for the positioning signal transmission as a sum of the positioning signal timings for each of the cells in the cell group multiplied by a weight, where the sum of each of the weights adds is 1. The weights may each be equal (i.e., the sum is average of the timings for each of the cells in the cell group) or may not be equal (e.g., a higher weight modifier may be applied to the timing of the primary cell and a lower weight modifier may be applied to the timing of a secondary cell).

In some aspects, the UE 702 may calculate a pathloss reference signal (PL-RS) for the positioning signal transmission 712 based on at least one PL-RS reference of a cell in the cell group. A PL-RS reference of a cell may include an SSB or a DL-PRS associated with the cell. In one example, the UE 702 may calculate the PL-RS based on the PL-RS reference of the cell that most recently served the UE 702. In another example, the UE 702 may assign a weight to each cell, where the weights sum to 1, and may multiply the PL-RS reference of each cell in the cell group against the corresponding weight to obtain a sum of weighted PL-RS values. The weights may be higher for BWPs closer to the middle of the BWP associated with the cell group than for BWPs closer to the edges of the BWP associated with the cell group. In another example, the UE 702 may average the LP-RS reference of each cell in the cell group to calculate the PL-RS for the positioning signal transmission 712.

In some aspects, the UE 702 may calculate a spatial relationship of the cell group, such as a QCL of the cell group, based on one cell of the cell group, for example the cell that most recently served the UE 702. In some aspects, the UE 702 may associate the cell group with a spatial relationship reference of any cell of the cell group. In some aspects, the UE 702 may associate the cell group with an average of the spatial relationship reference of each cell of the cell group (e.g., a calculated center of the cell group based on QCLs associated with each of the cell groups). A spatial relationship reference may include, for example, an SSB, a CSI-RS, a PRS, an SRS, a resource of an SRS, a resource position of an SRS, or a BWP. The SRS, CSI-RS, or BWP may be associated with the positioning signal transmission 712.

The UE 702 may transmit the positioning signal transmission 712 to the network entity 704. The positioning signal transmission may include a set of positioning signals associated with the positioning signal transmission (e.g., a set of SRSs). The set of positioning signals may be identified in the configuration 708. The UE 702 may transmit the positioning signal transmission 712 based on the cell group associated with the positioning signal transmission. For example, the UE 702 may transmit the positioning signal transmission 712 by transmitting the set of positioning signals to span the BWPs associated with each of the cells in the cell group associated with the positioning signal transmission 712. The configuration 708 may identify a transmission gap applicable to all of the cells in the cell group. During the transmission gap, the network entity 704 may not schedule any transmit or receive transmissions in any of the cells except for the positioning signal transmission. In other words, the UE 702 may not have any UL or DL transmissions with the cell group other than the set of positioning signals. The network entity 704 may calculate the transmission gap to be at least as long as an estimated time for the UE 702 to transmit the set of positioning signals added to a lead time and/or a return time gap. The lead time and/or return time gap may be calculated based on a UE capability of the UE 702. The return time for the transmission gap may be calculated similarly to the return time for a measurement gap. The transmission gap may be configured to have the same periodicity and offset as the positioning signal transmission.

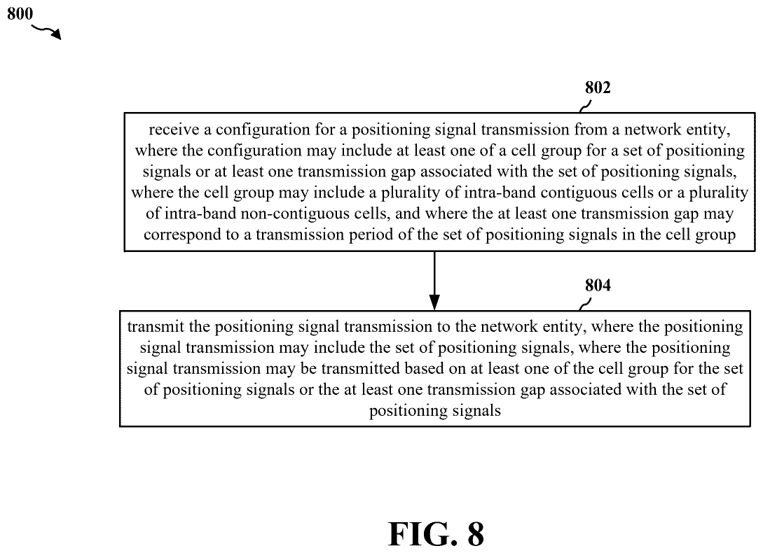

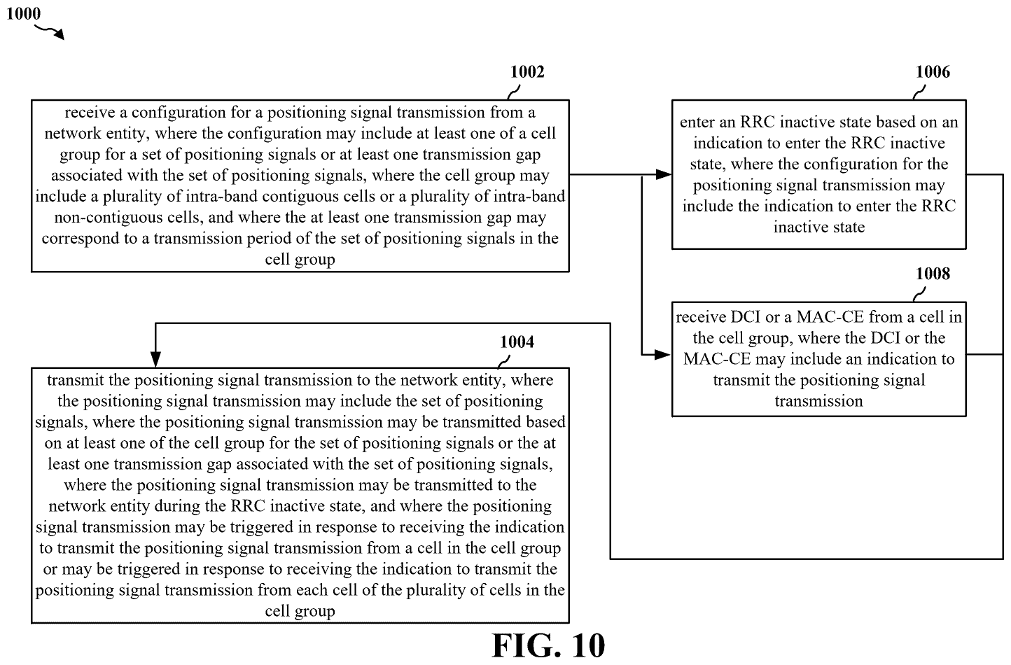

FIG. 8 is a flowchart 800 of a method of wireless communication. The method may be performed by a UE (e.g., the UE 104, UE 350, UE 618, UE 702; the apparatus 1304). At 802, the UE may receive a configuration for a positioning signal transmission from a network entity. The configuration may include at least one of a cell group for a set of positioning signals or at least one transmission gap associated with the set of positioning signals. The cell group may include a plurality of intra-band contiguous cells or a plurality of intra-band non-contiguous cells. The at least one transmission gap may correspond to a transmission period of the set of positioning signals in the cell group. For example, 802 may be performed by the UE 702 in FIG. 7, which may receive a configuration 708 for a positioning signal transmission 712 from the network entity 704. The configuration 708 may include at least one of a cell group (e.g., the cell group 602 in FIG. 6) for a set of positioning signals or at least one transmission gap associated with the set of positioning signals identified in the configuration 708. The UE 702 may transmit the positioning signal transmission 712 at the cell group during the transmission gap. The cell group may be associated with a plurality of intra-band contiguous cells, such as those seen in FIG. 5B, or a plurality of intra-band non-contiguous cells, such as those seen in FIG. 5A. The at least one transmission gap may correspond to a transmission period of the set of positioning signals in the cell group as defined in the configuration 708. 802 may also be performed by the component 198 in FIG. 10.

At 804, the UE may transmit the positioning signal transmission to the network entity. The positioning signal transmission may include the set of positioning signals. The positioning signal transmission may be transmitted based on at least one of the cell group for the set of positioning signals or the at least one transmission gap associated with the set of positioning signals. For example, 804 may be performed by the UE 702 in FIG. 7, which may transmit the positioning signal transmission 712 to the network entity 704. The positioning signal transmission 712 may include the set of positioning signals. The positioning signal transmission 712 may be transmitted based on at least one of the cell group for the set of positioning signals (e.g., by using a BWP that spans the BWP associated with each cell of the cell group) or the at least one transmission gap associated with the set of positioning signals that is scheduled to have no UL or DL transmissions with the UE 702 other than the set of positioning signals. 804 may also be performed by the component 198 in FIG. 10.

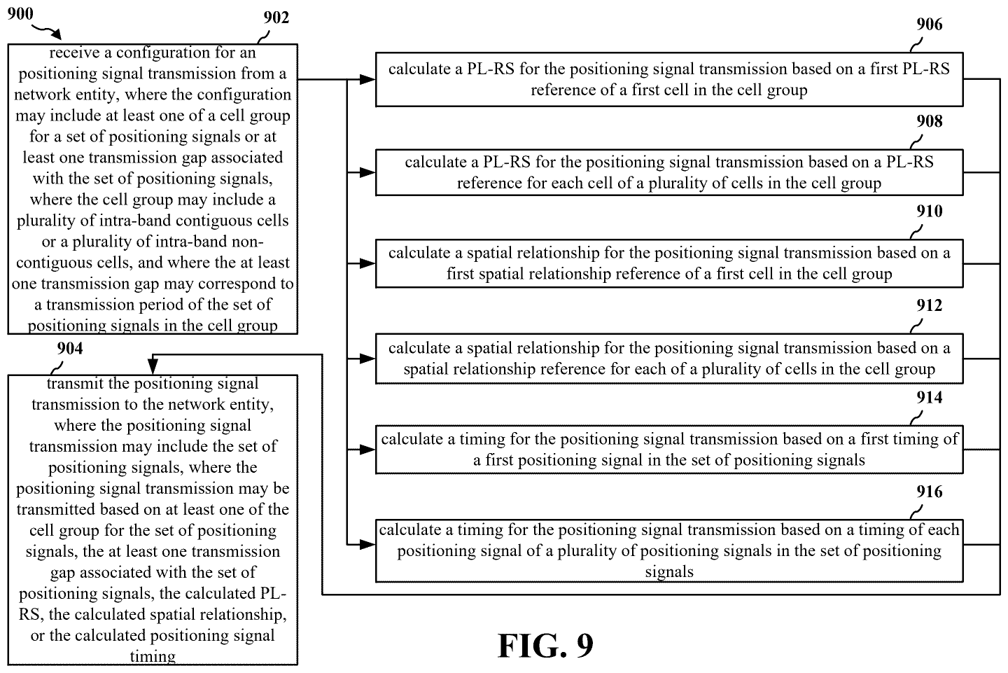

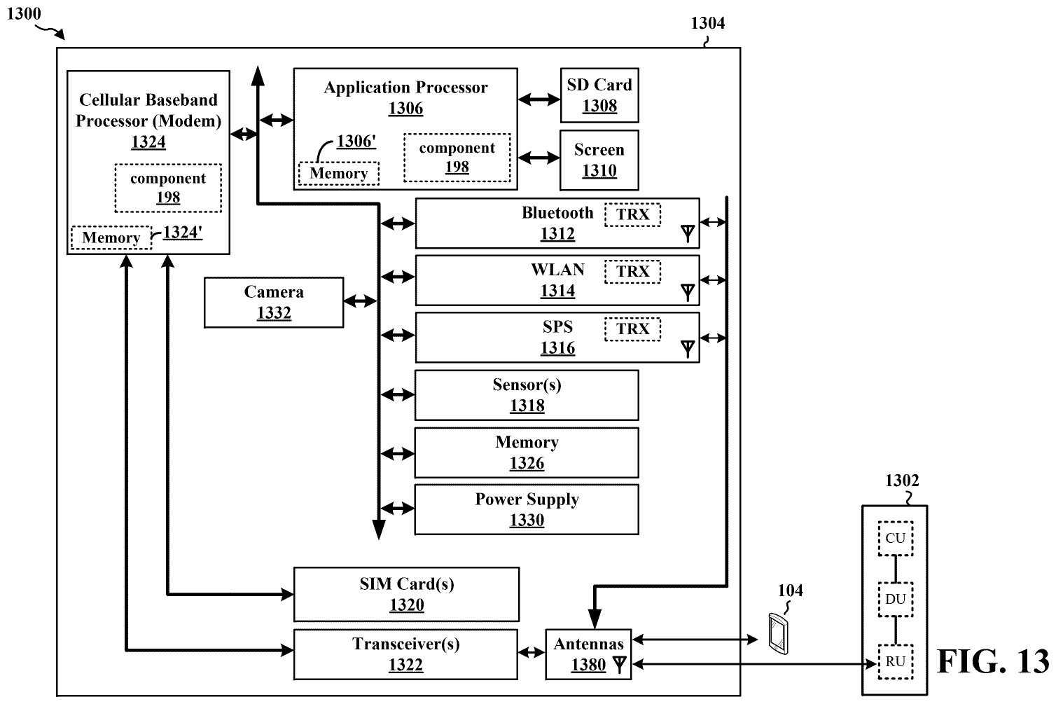

FIG. 9 is a flowchart 900 of a method of wireless communication. The method may be performed by a UE (e.g., the UE 104, UE 350, UE 618, UE 702; the apparatus 1304). At 902, the UE may receive a configuration for a positioning signal transmission from a network entity. The configuration may include at least one of a cell group for a set of positioning signals or at least one transmission gap associated with the set of positioning signals. The cell group may include a plurality of intra-band contiguous cells or a plurality of intra-band non-contiguous cells. The at least one transmission gap may correspond to a transmission period of the set of positioning signals in the cell group. For example, 902 may be performed by the UE 702 in FIG. 7, which may receive a configuration 708 for a positioning signal transmission 712 from the network entity 704. The configuration 708 may include at least one of a cell group (e.g., the cell group 602 in FIG. 6) for a set of positioning signals or at least one transmission gap associated with the set of positioning signals identified in the configuration 708. The cell group may include a plurality of intra-band contiguous cells, such as those seen in FIG. 5B, or a plurality of intra-band non-contiguous cells, such as those seen in FIG. 5A. The at least one transmission gap may correspond to a transmission period of the set of positioning signals in the cell group as defined in the configuration 708. 902 may also be performed by the component 198 in FIG. 13.

At 906, the UE may calculate a PL-RS for the positioning signal transmission based on a first PL-RS reference of a first cell in the cell group. For example, 906 may be performed by the UE 702 in FIG. 7, which may calculate a PL-RS for the positioning signal transmission 712 based on a PL-RS reference of a cell in the cell group, such as the SSB index of the primary cell 604 in the cell group 602. 906 may also be performed by the component 198 in FIG. 13.

At 908, the UE may calculate a PL-RS for the positioning signal transmission based on a PL-RS reference for each cell of a plurality of cells in the cell group. For example, 908 may be performed by the UE 702 in FIG. 7, which may calculate a PL-RS for the positioning signal transmission 712 based on a PL-RS reference of each cell in the cell group, such as an average of the SSB index of the primary cell 604 and the SSB index of the secondary cell 606 in the cell group 602. 908 may also be performed by the component 198 in FIG. 13.

At 910, the UE may calculate a spatial relationship for the positioning signal transmission based on a first spatial relationship reference of a first cell in the cell group. For example, 910 may be performed by the UE 702 in FIG. 7, which may calculate a spatial relationship for the positioning signal transmission 712 based on a spatial relationship reference of a cell in the cell group, such as a CSI-RS of the primary cell 604 in the cell group 602. 910 may also be performed by the component 198 in FIG. 13.

At 912, the UE may calculate a spatial relationship for the positioning signal transmission based on a spatial relationship reference for each of a plurality of cells in the cell group. For example, 912 may be performed by the UE 702 in FIG. 7, which may calculate a spatial relationship for the positioning signal transmission 712 based on a spatial relationship reference of each cell in the cell group, such as an average of the SSB index of the primary cell 604 and the SSB index of the secondary cell 606 in the cell group 602. 912 may also be performed by the component 198 in FIG. 13.

At 914, the UE may calculate a timing for the positioning signal transmission based on a first timing of a first positioning signal in the set of positioning signals. For example, 914 may be performed by the UE 702 in FIG. 7, which may calculate a timing for the positioning signal transmission 712 based on a timing of a positioning signal in the set of positioning signals, such as an SRS of a resource in a cell of the cell group or an SRS of a resource of the primary cell 604 in the cell group 602. 914 may also be performed by the component 198 in FIG. 13.

At 916, the UE may calculate a timing for the positioning signal transmission based on a timing of each positioning signal of a plurality of positioning signals in the set of positioning signals. For example, 914 may be performed by the UE 702 in FIG. 7, which may calculate a timing for the positioning signal transmission 712 based on a timing of each positioning signal in the set of positioning signals, such as each SRS of each resource in each cell of the cell group, or an average of the timing for SRSs of the primary cell 604 and the secondary cell 606 in the cell group 602. 916 may also be performed by the component 198 in FIG. 13.

At 904, the UE may transmit the positioning signal transmission to the network entity. The positioning signal transmission may include the set of positioning signals. The positioning signal transmission may be transmitted based on at least one of the cell group for the set of positioning signals, the at least one transmission gap associated with the set of positioning signals, the calculated PL-RS, the calculated spatial relationship, or the calculated timing. For example, 904 may be performed by the UE 702 in FIG. 7, which may transmit the positioning signal transmission 712 to the network entity 704. The positioning signal transmission 712 may include the set of positioning signals. The positioning signal transmission 712 may be transmitted based on at least one of the cell group for the set of positioning signals (e.g., by using a BWP that spans the BWP associated with each cell of the cell group), or based on the at least one transmission gap associated with the set of positioning signals that is scheduled to have no UL or DL transmissions with the UE 702 other than the set of positioning signals, or based on the calculated PL-RS timing from one or more cells of the cell group, or based on the calculated spatial relationship from one or more cells of the cell group, or based on the calculated timing from one or more resources of the cell group. 904 may also be performed by the component 198 in FIG. 13.

FIG. 10 is a flowchart 1000 of a method of wireless communication. The method may be performed by a UE (e.g., the UE 104, UE 350, UE 618, UE 702; the apparatus 1304). At 1002, the UE may receive a configuration for a positioning signal transmission from a network entity. The configuration may include at least one of a cell group for a set of positioning signals or at least one transmission gap associated with the set of positioning signals. The cell group may include a plurality of intra-band contiguous cells or a plurality of intra-band non-contiguous cells. The at least one transmission gap may correspond to a transmission period of the set of positioning signals in the cell group. For example, 1002 may be performed by the UE 702 in FIG. 7, which may receive a configuration 708 for a positioning signal transmission 712 from the network entity 704. The configuration 708 may include at least one of a cell group (e.g., the cell group 602 in FIG. 6) for a set of positioning signals or at least one transmission gap associated with the set of positioning signals identified in the configuration 708. The cell group may include a plurality of intra-band contiguous cells, such as those seen in FIG. 5B, or a plurality of intra-band non-contiguous cells, such as those seen in FIG. 5A. The at least one transmission gap may correspond to a transmission period of the set of positioning signals in the cell group as defined in the configuration 708. 1002 may also be performed by the component 198 in FIG. 13.

At 1006, the UE may enter an RRC inactive state based on an indication to enter the RRC inactive state. The configuration for the positioning signal transmission may include the indication to enter the RRC inactive state. For example, the UE 702 in FIG. 7 may enter an RRC inactive state based on an indication to enter the RRC inactive state from the configuration 708 received from the network entity 704. The configuration 708 for the positioning signal transmission 712 may include the indication to enter the RRC inactive state. 1006 may also be performed by the component 198 in FIG. 13.

At 1008, the UE may receive DCI or a MAC-CE from a cell in the cell group. The DCI or the MAC-CE may include an indication to transmit the positioning signal transmission. For example, the UE 618 in FIG. 6 may receive DCI or a MAC-CE from the primary cell 604 or the secondary cell 606 in the cell group 602. The DCI or MAC-CE may include an indication to transmit a positioning signal transmission, such as the positioning signal transmission 712 in FIG. 7. 1008 may also be performed by the component 198 in FIG. 13.

At 1004, the UE may transmit the positioning signal transmission to the network entity. The positioning signal transmission may include the set of positioning signals. The positioning signal transmission may be transmitted based on at least one of the cell group for the set of positioning signals or the at least one transmission gap associated with the set of positioning signals. The positioning signal transmission may be triggered in response to receiving the indication to transmit the positioning signal transmission from a cell in the cell group or may be triggered in response to receiving the indication to transmit the positioning signal transmission from each cell of the plurality of cells in the cell group. For example, 1004 may be performed by the UE 702 in FIG. 7, which may transmit the positioning signal transmission 712 to the network entity 704. The positioning signal transmission 712 may include the set of positioning signals. The positioning signal transmission 712 may be transmitted based on at least one of the cell group for the set of positioning signals (e.g., by using a BWP that spans the BWP associated with each cell of the cell group) or the at least one transmission gap associated with the set of positioning signals that is scheduled to have no UL or DL transmissions with the UE 702 other than the set of positioning signals. The positioning signal transmission 712 may be triggered in response to receiving the indication to transmit the positioning signal transmission 712 from the primary cell 604 in the cell group 602 in FIG. 6. In another aspect, the positioning signal transmission 712 may be triggered in response to receiving an indication to transmit the positioning signal transmission 712 from each of the primary cell 604 and the secondary cell 606 in the cell group 602 in FIG. 6. 1004 may also be performed by the component 198 in FIG. 10.

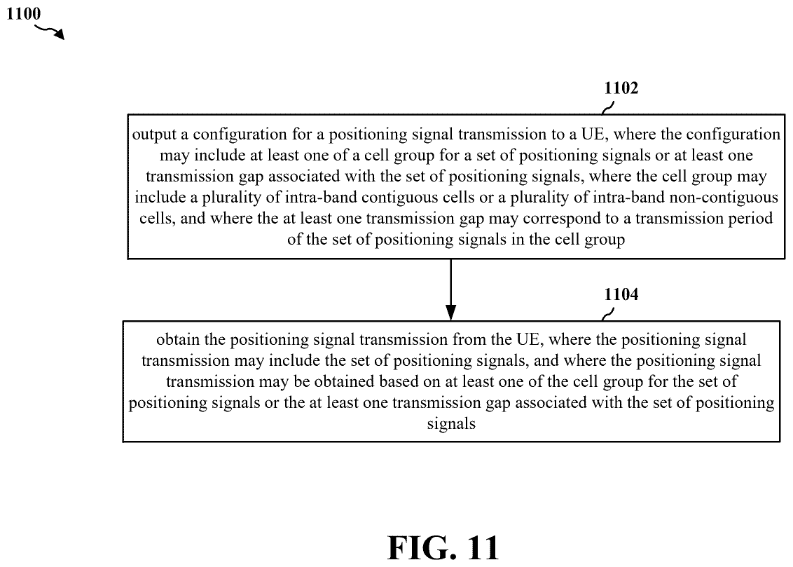

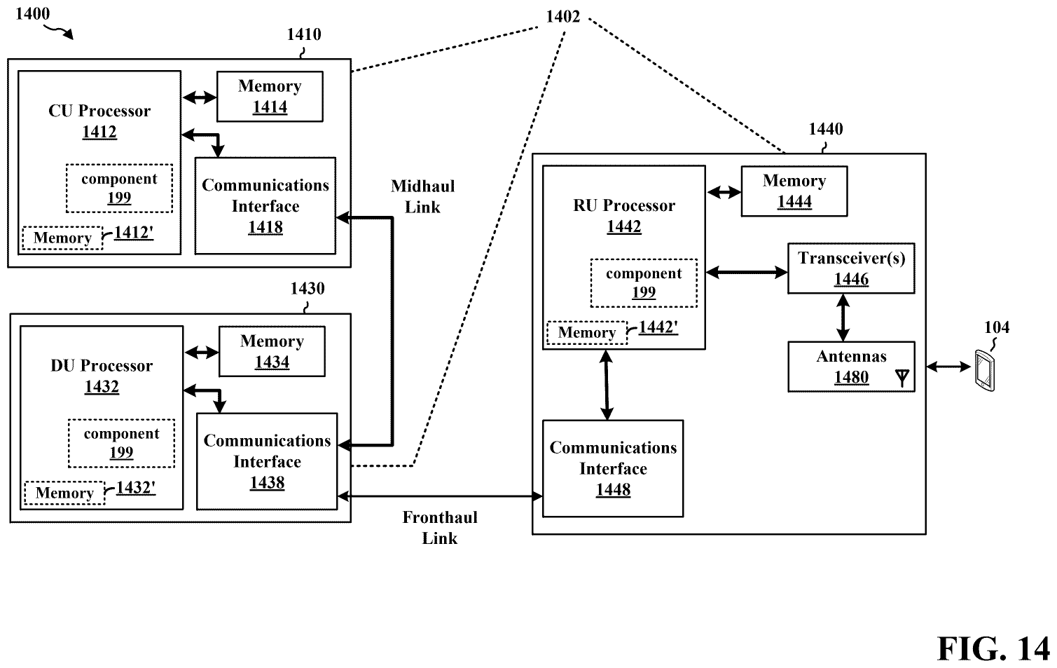

FIG. 11 is a flowchart 1100 of a method of wireless communication. The method may be performed by a base station (e.g., the base station 102, base station 310; the network entity 704, network entity 1302, network entity 1402). At 1102, the network entity may output a configuration for a positioning signal transmission to a UE. The configuration may include at least one of a cell group for a set of positioning signals or at least one transmission gap associated with the set of positioning signals. The cell group may include a plurality of intra-band contiguous cells or a plurality of intra-band non-contiguous cells. The at least one transmission gap may correspond to a transmission period of the set of positioning signals in the cell group. For example, 1102 may be performed by the network entity 704 in FIG. 7, which may output a configuration 708 for a positioning signal transmission 712 to the UE 702. The configuration 708 may include a cell group for a set of positioning signals. The configuration 708 may include at least one transmission gap associated with the positioning signals that are scheduled to have no UL or DL transmissions with the UE 702 other than the set of positioning signals. The cell group may include a plurality of intra-band contiguous cells such as those shown in FIG. 5B or a plurality of intra-band non-contiguous cells such as those shown in FIG. 5A. The at least one transmission gap may correspond to a transmission period of the set of positioning signals in the cell group that is scheduled to have no UL or DL transmissions with the UE 702 other than the set of positioning signals. 1102 may also be performed by the component 199 in FIG. 14.

At 1104, the network entity may obtain the positioning signal transmission from the UE. The positioning signal transmission may include the set of positioning signals. The positioning signal transmission may be obtained based on at least one of the cell group for the set of positioning signals or the at least one transmission gap associated with the set of positioning signals. For example, 1104 may be performed by the network entity 704 in FIG. 7, which may obtain the positioning signal transmission 712 from the UE 702. The positioning signal transmission 712 may include the set of positioning signals defined by the configuration 708. The positioning signal transmission 712 may be obtained based on the cell group for the set of positioning signals defined by the configuration 708 by using a BWP that spans the BWP of each cell in the cell group. The positioning signal transmission 712 may be obtained based on the transmission gap associated with the set of positioning signals by receiving the positioning signal transmission 712 during the transmission gap. 1104 may also be performed by the component 199 in FIG. 14.

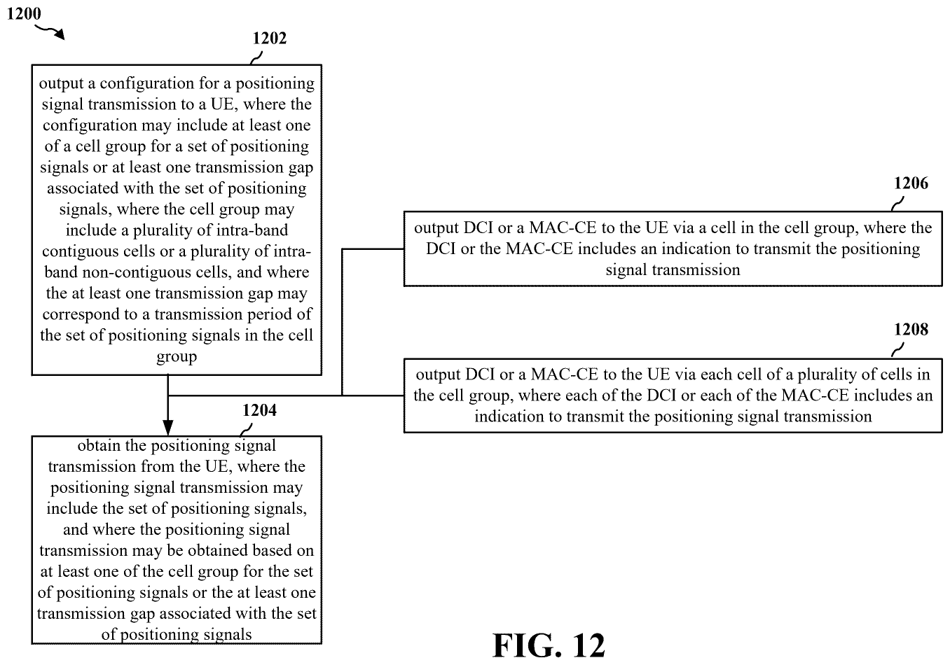

FIG. 12 is a flowchart 1200 of a method of wireless communication. The method may be performed by a base station (e.g., the base station 102, base station 310; the network entity 704, network entity 1302, network entity 1402). At 1202, the network entity may output a configuration for a positioning signal transmission to a UE. The configuration may include at least one of a cell group for a set of positioning signals or at least one transmission gap associated with the set of positioning signals. The cell group may include a plurality of intra-band contiguous cells or a plurality of intra-band non-contiguous cells. The at least one transmission gap may correspond to a transmission period of the set of positioning signals in the cell group. For example, 1202 may be performed by the network entity 704 in FIG. 7, which may output a configuration 708 for a positioning signal transmission 712 to the UE 702. The configuration 708 may include a cell group for a set of positioning signals. The configuration 708 may include at least one transmission gap associated with the positioning signals that are scheduled to have no UL or DL transmissions with the UE 702 other than the set of positioning signals. The cell group may include a plurality of intra-band contiguous cells such as those shown in FIG. 5B or a plurality of intra-band non-contiguous cells such as those shown in FIG. 5A. The at least one transmission gap may correspond to a transmission period of the set of positioning signals in the cell group that is scheduled to have no UL or DL transmissions with the UE 702 other than the set of positioning signals. 1202 may also be performed by the component 199 in FIG. 14.

At 1206, the network entity may output DCI or a MAC-CE to the UE via a cell in the cell group. The DCI or the MAC-CE may include an indication to transmit the positioning signal transmission. For example, 1206 may be performed by the primary TRP 610 in FIG. 6, which may output DCI or a MAC-CE to the UE 618 via the primary cell 604 in the cell group 602. The DCI or the MAC-CE may include an indication to transmit the positioning signal transmission, such as the positioning signal transmission 712 in FIG. 7. 1206 may also be performed by the component 199 in FIG. 14.

At 1208, the network entity may output DCI or a MAC-CE to the UE via each cell of a plurality of cells in the cell group. Each of the DCI or each of the MAC-CE may include an indication to transmit the positioning signal transmission. For example, 1206 may be performed by the primary TRP 610 in FIG. 6, which may output DCI or a MAC-CE to the UE 618 via each of the primary cell 604 and the secondary cell 606 in the cell group 602. Each of the DCI or the MAC-CE from the primary cell 604 and the secondary cell 606 may include an indication to transmit the positioning signal transmission, such as the positioning signal transmission 712 in FIG. 7. 1208 may also be performed by the component 199 in FIG. 14.

At 1204, the network entity may obtain the positioning signal transmission from the UE. The positioning signal transmission may include the set of positioning signals. The positioning signal transmission may be obtained based on at least one of the cell group for the set of positioning signals or the at least one transmission gap associated with the set of positioning signals. For example, 1204 may be performed by the network entity 704 in FIG. 7, which may obtain the positioning signal transmission 712 from the UE 702. The positioning signal transmission 712 may include the set of positioning signals defined by the configuration 708. The positioning signal transmission 712 may be obtained based on the cell group for the set of positioning signals defined by the configuration 708 by using a BWP that spans the BWP of each cell in the cell group. The positioning signal transmission 712 may be obtained based on the transmission gap associated with the set of positioning signals by receiving the positioning signal transmission 712 during the transmission gap. 1204 may also be performed by the component 199 in FIG. 14.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial management unit (IMU), gyroscope, and/or accelerometer(s), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRx) (or in some cases, just a receiver (Rx)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the Tx processor 368, the Rx processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see UE 350 of FIG. 3) and include the additional modules of the apparatus 1304.

As discussed supra, the component 198 may be configured to receive a configuration for a positioning signal transmission from a network entity. The configuration may include at least one of a cell group for a set of positioning signals or at least one transmission gap associated with the set of positioning signals. The cell group may include a plurality of intra-band contiguous cells or a plurality of intra-band non-contiguous cells. The at least one transmission gap may correspond to a transmission period of the set of positioning signals in the cell group. The component 198 may be configured to transmit the positioning signal transmission to the network entity. The positioning signal transmission may include the set of positioning signals. The positioning signal transmission may be transmitted based on at least one of the cell group for the set of positioning signals or the at least one transmission gap associated with the set of positioning signals. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, may include means for receiving a configuration for an SRS transmission from a network entity. The apparatus 1304 may include means for transmitting the SRS transmission to the network entity. The apparatus 1304 may include means for entering the RRC inactive state based on the indication to enter the RRC inactive state. The apparatus 1304 may include means for calculating a PL-RS for the SRS transmission based on a first PL-RS reference of a first cell in the cell group. The apparatus 1304 may include means for calculating a PL-RS for the SRS transmission based on a PL-RS reference for each cell of a plurality of cells in the cell group. The apparatus 1304 may include means for calculating a spatial relationship for the SRS transmission based on a first spatial relationship reference of a first cell in the cell group. The apparatus 1304 may include means for calculating a spatial relationship for the SRS transmission based on a spatial relationship reference for each of a plurality of cells in the cell group. The apparatus 1304 may include means for receiving DCI or a MAC-CE from a cell in the cell group. The apparatus 1304 may include means for receiving DCI or a MAC-CE from each cell of a plurality of cells in the cell group. The apparatus 1304 may include means for calculating an SRS timing for the SRS transmission based on a first timing of a first SRS in the set of SRSs. The apparatus 1304 may include means for calculating an SRS timing for the SRS transmission based on a timing of each SRS of a plurality of SRSs in the set of SRSs. The apparatus 1304 may include means for receiving a configuration for a positioning signal transmission from a network entity. The configuration may include a first indication of a cell group associated with a set of positioning signals or a second indication of at least one transmission gap associated with the set of positioning signals. The cell group may include a plurality of cells. The at least one transmission gap may correspond with at least one transmission period of the set of positioning signals. The apparatus 1304 may include means for transmitting the positioning signal transmission based on at least one of the cell group or the at least one transmission gap. The positioning signal transmission may include the set of positioning signals. The apparatus 1304 may include means for transmitting the positioning signal transmission by transmitting the positioning signal transmission during the at least one transmission gap. During the at least one transmission gap, the cell group may not be associated with any UL or DL transmissions other than the set of positioning signals. the configuration may include a list of resource sets. Each resource set in the list of resource sets may be associated with a plurality of positioning signal resources. The configuration may include a list of resource sets. Each resource set in the list of resource sets may be associated with a plurality of positioning signal resources. The configuration for the positioning signal transmission may be associated with an RRC inactive state. The apparatus 1304 may include means for entering the RRC inactive state. Transmitting the positioning signal transmission may include transmitting the positioning signal transmission during the RRC inactive state. The configuration comprises an indication of a first SCS associated with the positioning signal transmission. The first SCS may be different from a second SCS of a first cell in the cell group. The apparatus 1304 may include means for calculating a PL-RS for the positioning signal transmission based on a first PL-RS reference of a first cell in the cell group. The apparatus 1304 may include means for transmitting the positioning signal transmission by transmitting the positioning signal transmission based on the calculated PL-RS. The first PL-RS reference may include at least one of an SSB or a DL-PRS of the first cell in the cell group. The apparatus 1304 may include means for calculating a PL-RS for the positioning signal transmission based on a PL-RS reference for each cell of the plurality of cells in the cell group. The apparatus 1304 may include means for transmitting the positioning signal transmission by transmitting the positioning signal transmission based on the calculated PL-RS. The apparatus 1304 may include means for calculating a spatial relationship for the positioning signal transmission based on a first spatial relationship reference of a first cell in the cell group. The apparatus 1304 may include means for transmitting the positioning signal transmission by transmitting the positioning signal transmission based on the calculated spatial relationship. The first spatial relationship reference may include at least one of an SSB, a CSI-RS, a PRS, an SRS, a resource of a first SRS in the set of positioning signals, a resource position of a second SRS in the set of positioning signals, or a BWP. The apparatus 1304 may include means for calculating a spatial relationship for the positioning signal transmission based on a spatial relationship reference for each of the plurality of cells in the cell group. The apparatus 1304 may include means for transmitting the positioning signal transmission by transmitting the positioning signal transmission based on the calculated spatial relationship. The apparatus 1304 may include means for receiving DCI or a MAC-CE from a cell in the cell group. The DCI or the MAC-CE may include a third indication to transmit the positioning signal transmission. The apparatus 1304 may include means for transmitting the positioning signal transmission by transmitting the positioning signal transmission in response to the reception of the third indication from the cell in the cell group. The apparatus 1304 may include means for receiving the configuration for the positioning signal transmission by receiving an RRC configuration including the configuration for the positioning signal transmission. The apparatus 1304 may include means for receiving DCI or a MAC-CE from each cell of the plurality of cells in the cell group. The DCI or the MAC-CE may include a third indication to transmit the positioning signal transmission. The apparatus 1304 may include means for transmitting the positioning signal transmission by transmitting the positioning signal transmission in response to the reception of the third indication from each cell of the plurality of cells in the cell group. The apparatus 1304 may include means for calculating a timing for the positioning signal transmission based on a first timing of a first positioning signal in the set of positioning signals. The apparatus 1304 may include means for transmitting the positioning signal transmission by transmitting the positioning signal transmission based on the calculated timing. The apparatus 1304 may include means for calculating a timing for the positioning signal transmission based on a reference timing of each positioning signal of a plurality of positioning signals in the set of positioning signals. The apparatus 1304 may include means for transmitting the positioning signal transmission by transmitting the positioning signal transmission based on the calculated timing. The positioning signal transmission may include an SRS transmission. The set of positioning signals may include a set of SRSs. The configuration may include a third indication to periodically transmit the positioning signal transmission according to a schedule. The means may be the component 198 of the apparatus 1304 configured to perform the functions recited by the means. As described supra, the apparatus 1304 may include the Tx processor 368, the Rx processor 356, and the controller/processor 359. As such, in one configuration, the means may be the Tx processor 368, the Rx processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to output a configuration for a positioning signal transmission to a UE. The configuration may include at least one of a cell group for a set of positioning signals or at least one transmission gap associated with the set of positioning signals. The cell group may include a plurality of intra-band contiguous cells or a plurality of intra-band non-contiguous cells. The at least one transmission gap may correspond to a transmission period of the set of positioning signals in the cell group. The component 199 may further be configured to obtain the positioning signal transmission from the UE. The SRS transmission may include the set of positioning signals. The positioning signal transmission may be obtained based on at least one of the cell group for the set of positioning signals or the at least one transmission gap associated with the set of positioning signals. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 may include means for outputting a configuration for an SRS transmission to a UE. The configuration may include at least one of a cell group for a set of SRSs or at least one transmission gap associated with the set of SRSs. The cell group may include a plurality of intra-band contiguous cells or a plurality of intra-band non-contiguous cells. The at least one transmission gap may correspond to a transmission period of the set of SRSs in the cell group. The network entity 1402 may include means for obtaining the SRS transmission from the UE. The SRS transmission may include the set of SRSs. The SRS transmission may be obtained based on at least one of the cell group for the set of SRSs or the at least one transmission gap associated with the set of SRSs. The SRS transmission may be obtained during the at least one transmission gap. During the at least one transmission gap, the cell group may not be not associated with any UL or DL transmissions of the UE other than the set of SRSs. The configuration may include a list of SRS resource sets. Each SRS resource set in the list of SRS resource sets may be associated with a plurality of SRS resources. The configuration for the SRS transmission may include an indication to enter an RRC inactive state. The SRS transmission may be obtained during the RRC inactive state of the UE. The configuration may include an indication of a first SCS different from a second SCS of a first cell in the cell group. The configuration for the SRS transmission may include an indication to calculate a PL-RS for the SRS transmission based on a first PL-RS reference of a first cell in the cell group. The first PL-RS reference may include at least one of an SSB or a DL-PRS of the first cell in the cell group for the set of SRSs. The configuration for the SRS transmission may include an indication to calculate a PL-RS for the SRS transmission based on a PL-RS reference for each cell of a plurality of cells in the cell group. The configuration for the SRS transmission may include an indication to calculate a spatial relationship for the SRS transmission based on a first spatial relationship reference of a first cell in the cell group. The first spatial relationship reference may include at least one of an SSB, a CSI-RS, a PRS, a resource of a first SRS in the set of SRSs, a resource position of an SRS in the set of SRSs, or a BWP. The configuration for the SRS transmission may include an indication to calculate a spatial relationship for the SRS transmission based on a spatial relationship reference for each of a plurality of cells in the cell group. The network entity 1402 may include means for outputting DCI or a MAC-CE to the UE via a cell in the cell group. The DCI or the MAC-CE may include an indication to transmit the SRS transmission. The network entity 1402 may include means for outputting DCI or a MAC-CE to the UE via each cell of a plurality of cells in the cell group. Each of the DCI or each of the MAC-CE may include an indication to transmit the SRS transmission. The configuration for the SRS transmission may include an indication to calculate an SRS timing for the SRS transmission based on a first timing of a first SRS in the set of SRSs. The configuration for the SRS transmission may include an indication to calculate an SRS timing for the SRS transmission based on a timing of each SRS of a plurality of SRSs in the set of SRSs. The network entity 1402 may include means for transmitting a configuration for a positioning signal transmission to a UE. The configuration may include a first indication of a cell group for a set of positioning signals or a second indication of at least one transmission gap associated with the set of positioning signals. The cell group may include a plurality cells. The at least one transmission gap may correspond with at least one transmission period of the set of positioning signals. The network entity 1402 may include means for receiving the positioning signal transmission from the UE based on at least one of the cell group for the set of positioning signals or the at least one transmission gap associated with the set of positioning signals. The positioning signal transmission may include the set of positioning signals. The network entity 1402 may include means for receiving the positioning signal transmission by receiving the positioning signal transmission during the at least one transmission gap. During the at least one transmission gap, the cell group may not be associated with any UL or DL transmissions with the UE other than the set of positioning signals. The configuration for the positioning signal transmission may be associated with an RRC inactive state. The network entity 1402 may include means for receiving the positioning signal transmission by receiving the positioning signal transmission during the RRC inactive state of the UE. The configuration may include a list of resource sets. Each resource set in the list of resource sets may be associated with a plurality of positioning signal resources. The configuration may include an indication of a first SCS different from a second SCS of a first cell in the cell group. The configuration for the positioning signal transmission may include an indication to calculate a PL-RS for the positioning signal transmission based on a first PL-RS reference of a first cell in the cell group. The first PL-RS reference may include at least one of an SSB or a DL-PRS of the first cell in the cell group for the set of positioning signals. The configuration for the positioning signal transmission may include an indication to calculate a PL-RS for the positioning signal transmission based on a PL-RS reference for each cell of a plurality of cells in the cell group. The configuration for the positioning signal transmission may include an indication to calculate a PL-RS for the positioning signal transmission based on a PL-RS reference for each cell of a plurality of cells in the cell group. The first spatial relationship reference may include at least one of an SSB, a CSI-RS, a PRS, an SRS, a resource of a first SRS in the set of positioning signals, a resource position of a second SRS in the set of positioning signals, or a BWP. The configuration for the positioning signal transmission may include a third indication to calculate a spatial relationship for the positioning signal transmission based on a spatial relationship reference for each of a plurality of cells in the cell group. The network entity 1402 may include means for outputting DCI or a MAC-CE to the UE via a cell in the cell group. The DCI or the MAC-CE may include a third indication to transmit the positioning signal transmission. The network entity 1402 may include means for transmitting the configuration for the positioning signal transmission by transmitting an RRC configuration including the configuration for the positioning signal transmission. The network entity 1402 may include means for outputting DCI or a MAC-CE to the UE via each cell of a plurality of cells in the cell group. Each of the DCI or each of the MAC-CE may include an indication to transmit the SRS transmission. The configuration for the positioning signal transmission may include a third indication to calculate a timing for the positioning signal transmission based on a first timing of a first positioning signal in the set of positioning signals. The configuration for the positioning signal transmission may include a third indication to calculate a timing for the positioning signal transmission based on a timing of each positioning signal of a plurality of positioning signals in the set of positioning signals. The positioning signal transmission may include an SRS transmission. The set of positioning signals may include a set of SRSs. The configuration may include a third indication to periodically transmit the positioning signal transmission according to a schedule. The means may be the component 199 of the network entity 1402 configured to perform the functions recited by the means. As described supra, the network entity 1402 may include the Tx processor 316, the Rx processor 370, and the controller/processor 375. As such, in one configuration, the means may be the Tx processor 316, the Rx processor 370, and/or the controller/processor 375 configured to perform the functions recited by the means.

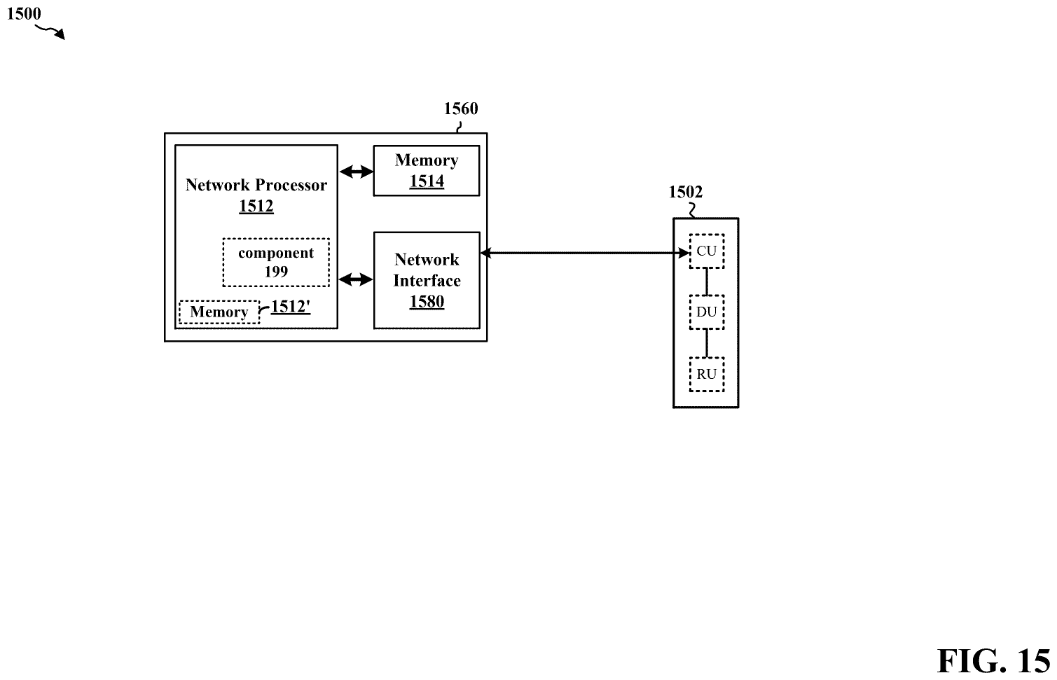

FIG. 15 is a diagram 1500 illustrating an example of a hardware implementation for a network entity 1560. In one example, the network entity 1560 may be within the core network 120. The network entity 1560 may include a network processor 1512. The network processor 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The processor 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to output a configuration for a positioning signal transmission to a UE. The configuration may include at least one of a cell group for a set of positioning signals or at least one transmission gap associated with the set of positioning signals. The cell group may include a plurality of intra-band contiguous cells or a plurality of intra-band non-contiguous cells. The at least one transmission gap may correspond to a transmission period of the set of positioning signals in the cell group. The component 199 may further be configured to obtain the positioning signal transmission from the UE. The SRS transmission may include the set of positioning signals. The positioning signal transmission may be obtained based on at least one of the cell group for the set of positioning signals or the at least one transmission gap associated with the set of positioning signals. The component 199 may be within the processor 1512. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1560 may include a variety of components configured for various functions. In one configuration, the network entity 1560 may include means for outputting a configuration for an SRS transmission to a UE. The configuration may include at least one of a cell group for a set of SRSs or at least one transmission gap associated with the set of SRSs. The cell group may include a plurality of intra-band contiguous cells or a plurality of intra-band non-contiguous cells. The at least one transmission gap may correspond to a transmission period of the set of SRSs in the cell group. The network entity 1560 may include means for obtaining the SRS transmission from the UE. The SRS transmission may include the set of SRSs. The SRS transmission may be obtained based on at least one of the cell group for the set of SRSs or the at least one transmission gap associated with the set of SRSs. The SRS transmission may be obtained during the at least one transmission gap. During the at least one transmission gap, the cell group may not be not associated with any UL or DL transmissions of the UE other than the set of SRSs. The configuration may include a list of SRS resource sets. Each SRS resource set in the list of SRS resource sets may be associated with a plurality of SRS resources. The configuration for the SRS transmission may include an indication to enter an RRC inactive state. The SRS transmission may be obtained during the RRC inactive state of the UE. The configuration may include an indication of a first SCS different from a second SCS of a first cell in the cell group. The configuration for the SRS transmission may include an indication to calculate a PL-RS for the SRS transmission based on a first PL-RS reference of a first cell in the cell group. The first PL-RS reference may include at least one of an SSB or a DL-PRS of the first cell in the cell group for the set of SRSs. The configuration for the SRS transmission may include an indication to calculate a PL-RS for the SRS transmission based on a PL-RS reference for each cell of a plurality of cells in the cell group. The configuration for the SRS transmission may include an indication to calculate a spatial relationship for the SRS transmission based on a first spatial relationship reference of a first cell in the cell group. The first spatial relationship reference may include at least one of an SSB, a CSI-RS, a PRS, a resource of a first SRS in the set of SRSs, a resource position of an SRS in the set of SRSs, or a BWP. The configuration for the SRS transmission may include an indication to calculate a spatial relationship for the SRS transmission based on a spatial relationship reference for each of a plurality of cells in the cell group. The network entity 1560 may include means for outputting DCI or a MAC-CE to the UE via a cell in the cell group. The DCI or the MAC-CE may include an indication to transmit the SRS transmission. The network entity 1560 may include means for outputting DCI or a MAC-CE to the UE via each cell of a plurality of cells in the cell group. Each of the DCI or each of the MAC-CE may include an indication to transmit the SRS transmission. The configuration for the SRS transmission may include an indication to calculate an SRS timing for the SRS transmission based on a first timing of a first SRS in the set of SRSs. The configuration for the SRS transmission may include an indication to calculate an SRS timing for the SRS transmission based on a timing of each SRS of a plurality of SRSs in the set of SRSs. The network entity 1560 may include means for transmitting a configuration for a positioning signal transmission to a UE. The configuration may include a first indication of a cell group for a set of positioning signals or a second indication of at least one transmission gap associated with the set of positioning signals. The cell group may include a plurality cells. The at least one transmission gap may correspond with at least one transmission period of the set of positioning signals. The network entity 1560 may include means for receiving the positioning signal transmission from the UE based on at least one of the cell group for the set of positioning signals or the at least one transmission gap associated with the set of positioning signals. The positioning signal transmission may include the set of positioning signals. The network entity 1560 may include means for receiving the positioning signal transmission by receiving the positioning signal transmission during the at least one transmission gap. During the at least one transmission gap, the cell group may not be associated with any UL or DL transmissions with the UE other than the set of positioning signals. The configuration for the positioning signal transmission may be associated with an RRC inactive state. The network entity 1560 may include means for receiving the positioning signal transmission by receiving the positioning signal transmission during the RRC inactive state of the UE. The configuration may include a list of resource sets. Each resource set in the list of resource sets may be associated with a plurality of positioning signal resources. The configuration may include an indication of a first SCS different from a second SCS of a first cell in the cell group. The configuration for the positioning signal transmission may include an indication to calculate a PL-RS for the positioning signal transmission based on a first PL-RS reference of a first cell in the cell group. The first PL-RS reference may include at least one of an SSB or a DL-PRS of the first cell in the cell group for the set of positioning signals. The configuration for the positioning signal transmission may include an indication to calculate a PL-RS for the positioning signal transmission based on a PL-RS reference for each cell of a plurality of cells in the cell group. The configuration for the positioning signal transmission may include an indication to calculate a PL-RS for the positioning signal transmission based on a PL-RS reference for each cell of a plurality of cells in the cell group. The first spatial relationship reference may include at least one of an SSB, a CSI-RS, a PRS, an SRS, a resource of a first SRS in the set of positioning signals, a resource position of a second SRS in the set of positioning signals, or a BWP. The configuration for the positioning signal transmission may include a third indication to calculate a spatial relationship for the positioning signal transmission based on a spatial relationship reference for each of a plurality of cells in the cell group. The network entity 1560 may include means for outputting DCI or a MAC-CE to the UE via a cell in the cell group. The DCI or the MAC-CE may include a third indication to transmit the positioning signal transmission. The network entity 1560 may include means for transmitting the configuration for the positioning signal transmission by transmitting an RRC configuration including the configuration for the positioning signal transmission. The network entity 1560 may include means for outputting DCI or a MAC-CE to the UE via each cell of a plurality of cells in the cell group. Each of the DCI or each of the MAC-CE may include an indication to transmit the SRS transmission. The configuration for the positioning signal transmission may include a third indication to calculate a timing for the positioning signal transmission based on a first timing of a first positioning signal in the set of positioning signals. The configuration for the positioning signal transmission may include a third indication to calculate a timing for the positioning signal transmission based on a timing of each positioning signal of a plurality of positioning signals in the set of positioning signals. The positioning signal transmission may include an SRS transmission. The set of positioning signals may include a set of SRSs. The configuration may include a third indication to periodically transmit the positioning signal transmission according to a schedule. The means may be the component 199 of the network entity 1560 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, including receiving a configuration for an SRS transmission from a network entity. The configuration may include at least one of a cell group for a set of SRSs or at least one transmission gap associated with the set of SRSs. The cell group may include a plurality of intra-band contiguous cells or a plurality of intra-band non-contiguous cells. The at least one transmission gap may correspond to a transmission period of the set of SRSs in the cell group. The method may further include transmitting the SRS transmission to the network entity. The SRS transmission may include the set of SRSs. The SRS transmission may be transmitted based on at least one of the cell group for the set of SRSs or the at least one transmission gap associated with the set of SRSs.

Aspect 2 is the method of aspect 1, where the SRS transmission may be transmitted to the network entity during the at least one transmission gap. During the at least one transmission gap, the cell group may not be not associated with any UL or DL transmissions other than the set of SRSs.

Aspect 3 is the method of aspect 2, where the at least one transmission gap may be between a first transmission associated with a first cell of the plurality of intra-band non-contiguous cells and a second transmission associated with a second cell of the plurality of intra-band non-contiguous cells.

Aspect 4 is the method of any of aspects 1 to 3, where the configuration may further include a list of SRS resource sets.

Aspect 5 is the method of aspect 4, where each SRS resource set in the list of SRS resource sets may be associated with a plurality of SRS resources.

Aspect 6 is the method of any of aspects 1 to 5, where the configuration for the SRS transmission may include an indication to enter an RRC inactive state.

Aspect 7 is the method of aspect 6, further including entering the RRC inactive state based on the indication to enter the RRC inactive state. The SRS transmission may be transmitted to the network entity during the RRC inactive state.

Aspect 8 is the method of any of aspects 1 to 7, where the configuration includes an indication of a first SCS different from a second SCS of a first cell in the cell group

Aspect 9 is the method of any of aspects 1 to 8, further including calculating a PL-RS for the SRS transmission based on a first PL-RS reference of a first cell in the cell group. The SRS transmission may be transmitted to the network entity based on the calculated PL-RS.

Aspect 10 is the method of aspect 9, where the first PL-RS reference includes at least one of an SSB or a DL-PRS of the first cell in the cell group.

Aspect 11 s the method of any of aspects 1 to 10, further including calculating a PL-RS for the SRS transmission based on a PL-RS reference for each cell of a plurality of cells in the cell group. The SRS transmission may be transmitted to the network entity based on the calculated PL-RS.

Aspect 12 is the method of any of aspects 1 to 11, further including calculating a spatial relationship for the SRS transmission based on a first spatial relationship reference of a first cell in the cell group. The SRS transmission may be transmitted to the network entity based on the calculated spatial relationship.

Aspect 13 is the method of any of aspects 1 to 12, where the first spatial relationship reference may include at least one of an SSB, a CSI-RS, a PRS, a resource of a first SRS in the set of SRSs, a resource position of an SRS in the set of SRSs, or a BWP.

Aspect 14 is the method of any of aspects 1 to 13, further including calculating a spatial relationship for the SRS transmission based on a spatial relationship reference for each of a plurality of cells in the cell group. The SRS transmission may be transmitted to the network entity based on the calculated spatial relationship.

Aspect 15 is the method of any of aspects 1 to 14, further including receiving DCI or a MAC-CE from a cell in the cell group. The DCI or the MAC-CE may include an indication to transmit the SRS transmission. The SRS transmission may be triggered in response to receiving the indication to transmit the SRS transmission.

Aspect 16 is the method of any of aspects 1 to 15, further including receiving DCI or a MAC-CE from each cell of a plurality of cells in the cell group. The DCI or the MAC-CE may include an indication to transmit the SRS transmission. The SRS transmission may be triggered in response to receiving the indication to transmit the SRS transmission from each cell of the plurality of cells in the cell group.

Aspect 17 is the method of any of aspects 1 to 16, further including calculating an SRS timing for the SRS transmission based on a first timing of a first SRS in the set of SRSs. The SRS transmission may be transmitted to the network entity based on the calculated SRS timing.

Aspect 18 is the method of any of aspects 1 to 17, further including calculating an SRS timing for the SRS transmission based on a timing of each SRS of a plurality of SRSs in the set of SRSs. The SRS transmission may be transmitted to the network entity based on the calculated SRS timing.

Aspect 19 is a method of wireless communication at a network entity, including outputting a configuration for an SRS transmission to a UE. The configuration may include at least one of a cell group for a set of SRSs or at least one transmission gap associated with the set of SRSs. The cell group may include a plurality of intra-band contiguous cells or a plurality of intra-band non-contiguous cells. The at least one transmission gap may correspond to a transmission period of the set of SRSs in the cell group. The method may further include obtaining the SRS transmission from the UE. The SRS transmission may include the set of SRSs. The SRS transmission may be obtained based on at least one of the cell group for the set of SRSs or the at least one transmission gap associated with the set of SRSs.

Aspect 20 is the method of aspect 19, where the SRS transmission may be obtained during the at least one transmission gap. During the at least one transmission gap, the cell group may not be not associated with any UL or DL transmissions of the UE other than the set of SRSs.

Aspect 21 is the method of either of aspects 19 to 20, where the configuration further includes a list of SRS resource sets.

Aspect 22 is the method of any of aspects 19 to 21, where each SRS resource set in the list of SRS resource sets may be associated with a plurality of SRS resources.

Aspect 23 is the method of any of aspects 19 to 22, where the configuration for the SRS transmission may include an indication to enter an RRC inactive state.

Aspect 24 is the method of any of aspects 19 to 23, where the SRS transmission may be obtained during the RRC inactive state of the UE.

Aspect 25 is the method of any of aspects 19 to 24, where the configuration may include an indication of a first SCS different from a second SCS of a first cell in the cell group.

Aspect 26 is the method of any of aspects 19 to 25, where the configuration for the SRS transmission may include an indication to calculate a PL-RS for the SRS transmission based on a first PL-RS reference of a first cell in the cell group.

Aspect 27 is the method of any of aspects 19 to 26, where the first PL-RS reference may include at least one of an SSB or a DL-PRS of the first cell in the cell group for the set of SRSs.

Aspect 28 is the method of any of aspects 19 to 27, where the configuration for the SRS transmission may include an indication to calculate a PL-RS for the SRS transmission based on a PL-RS reference for each cell of a plurality of cells in the cell group.

Aspect 29 is the method of any of aspects 19 to 28, where the configuration for the SRS transmission may include an indication to calculate a spatial relationship for the SRS transmission based on a first spatial relationship reference of a first cell in the cell group.

Aspect 30 is the method of any of aspects 19 to 29, where the first spatial relationship reference may include at least one of an SSB, a CSI-RS, a PRS, a resource of a first SRS in the set of SRSs, a resource position of an SRS in the set of SRSs, or a BWP.

Aspect 31 is the method of any of aspects 19 to 30, where the configuration for the SRS transmission may include an indication to calculate a spatial relationship for the SRS transmission based on a spatial relationship reference for each of a plurality of cells in the cell group.

Aspect 32 is the method of any of aspects 19 to 31, further including outputting DCI or a MAC-CE to the UE via a cell in the cell group. The DCI or the MAC-CE may include an indication to transmit the SRS transmission.

Aspect 33 is the method of any of aspects 19 to 32, further including outputting DCI or a MAC-CE to the UE via each cell of a plurality of cells in the cell group. Each of the DCI or each of the MAC-CE may include an indication to transmit the SRS transmission.

Aspect 34 is the method of any of aspects 19 to 33, where the configuration for the SRS transmission may include an indication to calculate an SRS timing for the SRS transmission based on a first timing of a first SRS in the set of SRSs.

Aspect 35 is the method of any of aspects 19 to 34, where the configuration for the SRS transmission may include an indication to calculate an SRS timing for the SRS transmission based on a timing of each SRS of a plurality of SRSs in the set of SRSs.

Aspect 36 is an apparatus for wireless communication at a UE, including: a memory; and at least one processor coupled to the memory and, based at least in part on information stored in the memory, the at least one processor is configured to implement any of aspects 1 to 18.

Aspect 37 is the apparatus of aspect 36, further including at least one of an antenna or a transceiver coupled to the at least one processor.

Aspect 38 is an apparatus for wireless communication including means for implementing any of aspects 1 to 18.

Aspect 39 is a computer-readable medium (e.g., a non-transitory computer-readable medium) storing computer executable code, where the code when executed by a processor causes the processor to implement any of aspects 1 to 18.

Aspect 40 is an apparatus for wireless communication at a network entity, including: a memory; and at least one processor coupled to the memory and, based at least in part on information stored in the memory, the at least one processor is configured to implement any of aspects 19 to 35.

Aspect 41 is the apparatus of aspect 40, further including at least one of an antenna or a transceiver coupled to the at least one processor.

Aspect 42 is an apparatus for wireless communication including means for implementing any of aspects 19 to 35.

Aspect 43 is a computer-readable medium (e.g., a non-transitory computer-readable medium) storing computer executable code, where the code when executed by a processor causes the processor to implement any of aspects 19 to 35.

Aspect 44 is a method of wireless communication at a user equipment (UE), where the method may include receiving a configuration for a positioning signal transmission from a network entity. The configuration may include a first indication of a cell group associated with a set of positioning signals or a second indication of at least one transmission gap associated with the set of positioning signals. The cell group may include a plurality of cells. The at least one transmission gap may correspond with at least one transmission period of the set of positioning signals. The method may include transmitting the positioning signal transmission based on at least one of the cell group or the at least one transmission gap. The positioning signal transmission may include the set of positioning signals.

Aspect 45 is the method of aspect 44, where transmitting the positioning signal transmission may include transmitting the positioning signal transmission during the at least one transmission gap. During the at least one transmission gap, the cell group may not be associated with any uplink (UL) or downlink (DL) transmissions other than the set of positioning signals.

Aspect 46 is the method of either aspects 44 or 45, where the configuration may include a list of resource sets. Each resource set in the list of resource sets may be associated with a plurality of positioning signal resources.

Aspect 47 is the method of any of aspects 44 to 46, where the configuration for the positioning signal transmission may be associated with a radio resource control (RRC) inactive state. The method may include entering the RRC inactive state. Transmitting the positioning signal transmission may include transmitting the positioning signal transmission during the RRC inactive state.

Aspect 48 is the method of any of aspects 44 to 47, where the configuration comprises an indication of a first sub-carrier spacing (SCS) associated with the positioning signal transmission. The first SCS may be different from a second SCS of a first cell in the cell group.

Aspect 49 is the method of any of aspects 44 to 48, where the method may include calculating a pathloss reference signal (PL-RS) for the positioning signal transmission based on a first PL-RS reference of a first cell in the cell group. Transmitting the positioning signal transmission may include transmitting the positioning signal transmission based on the calculated PL-RS.

Aspect 50 is the method of aspect 49, where the first PL-RS reference may include at least one of a synchronization signal block (SSB) or a downlink positioning reference signal (DL-PRS) of the first cell in the cell group.

Aspect 51 is the method of any of aspects 44 to 50, where the method may include calculating a pathloss reference signal (PL-RS) for the positioning signal transmission based on a PL-RS reference for each cell of the plurality of cells in the cell group. Transmitting the positioning signal transmission may include transmitting the positioning signal transmission based on the calculated PL-RS.

Aspect 52 is the method of any of aspects 44 to 51, where the method may include calculating a spatial relationship for the positioning signal transmission based on a first spatial relationship reference of a first cell in the cell group. Transmitting the positioning signal transmission may include transmitting the positioning signal transmission based on the calculated spatial relationship.

Aspect 53 is the method of aspect 52, where the first spatial relationship reference may include at least one of a synchronization signal block (SSB), a channel state information (CSI) reference signal (CSI-RS), a positioning reference signal (PRS), a sounding reference signal (SRS), a resource of a first SRS in the set of positioning signals, a resource position of a second SRS in the set of positioning signals, or a bandwidth part (BWP).

Aspect 54 is the method of any of aspects 44 to 53, where the method may include calculating a spatial relationship for the positioning signal transmission based on a spatial relationship reference for each of the plurality of cells in the cell group. Transmitting the positioning signal transmission may include transmitting the positioning signal transmission based on the calculated spatial relationship.

Aspect 55 is the method of any of aspects 44 to 54, where the method may include receiving downlink control information (DCI) or a medium access control (MAC) control element (MAC-CE) from a cell in the cell group. The DCI or the MAC-CE may include a third indication to transmit the positioning signal transmission. Transmitting the positioning signal transmission may include transmitting the positioning signal transmission in response to the reception of the third indication from the cell in the cell group.

Aspect 56 is the method of aspect 55, where receiving the configuration for the positioning signal transmission may include receiving a radio resource control (RRC) configuration including the configuration for the positioning signal transmission.

Aspect 57 is the method of any of aspects 44 to 56, where the method may include receiving DCI or a MAC-CE from each cell of the plurality of cells in the cell group. The DCI or the MAC-CE may include a third indication to transmit the positioning signal transmission. Transmitting the positioning signal transmission may include transmitting the positioning signal transmission in response to the reception of the third indication from each cell of the plurality of cells in the cell group.

Aspect 58 is the method of any of aspects 44 to 57, where the method may include calculating a timing for the positioning signal transmission based on a first timing of a first positioning signal in the set of positioning signals. Transmitting the positioning signal transmission may include transmitting the positioning signal transmission based on the calculated timing.

Aspect 59 is the method of any of aspects 44 to 58, where the method may include calculating a timing for the positioning signal transmission based on a reference timing of each positioning signal of a plurality of positioning signals in the set of positioning signals. Transmitting the positioning signal transmission may include transmitting the positioning signal transmission based on the calculated timing.

Aspect 60 is the method of any of aspects 44 to 59, where the positioning signal transmission may include a sounding reference signal (SRS) transmission. The set of positioning signals may include a set of SRSs.

Aspect 61 is the method of any of aspects 44 to 60, where the configuration may include a third indication to periodically transmit the positioning signal transmission according to a schedule.

Aspect 62 is a method of wireless communication at a network entity, where the method may include transmitting a configuration for a positioning signal transmission to a user equipment (UE). The configuration may include a first indication of a cell group for a set of positioning signals or a second indication of at least one transmission gap associated with the set of positioning signals. The cell group may include a plurality cells. The at least one transmission gap may correspond with at least one transmission period of the set of positioning signals. The method may include receiving the positioning signal transmission from the UE based on at least one of the cell group for the set of positioning signals or the at least one transmission gap associated with the set of positioning signals. The positioning signal transmission may include the set of positioning signals.

Aspect 63 is the method of aspect 62, where receiving the positioning signal transmission may include receiving the positioning signal transmission during the at least one transmission gap. During the at least one transmission gap, the cell group may not be associated with any uplink (UL) or downlink (DL) transmissions with the UE other than the set of positioning signals.

Aspect 64 is the method of either of aspects 62 or 63, where the configuration for the positioning signal transmission may be associated with a radio resource control (RRC) inactive state. Receiving the positioning signal transmission may include receiving the positioning signal transmission during the RRC inactive state of the UE.

Aspect 65 is the method of any of aspects 62 to 64, where the configuration may include a list of resource sets.

Aspect 66 is the method of aspect 65, where each resource set in the list of resource sets may be associated with a plurality of positioning signal resources.

Aspect 67 is the method of any of aspects 62 to 66, where the configuration may include an indication of a first sub-carrier spacing (SCS) different from a second SCS of a first cell in the cell group.

Aspect 68 is the method of any of aspects 62 to 67, where the configuration for the positioning signal transmission may include an indication to calculate a pathloss reference signal (PL-RS) for the positioning signal transmission based on a first PL-RS reference of a first cell in the cell group.

Aspect 69 is the method of aspect 68, where the first PL-RS reference may include at least one of a synchronization signal block (SSB) or a downlink positioning reference signal (DL-PRS) of the first cell in the cell group for the set of positioning signals.

Aspect 70 is the method of any of aspects 62 to 69, where the configuration for the positioning signal transmission may include an indication to calculate a pathloss reference signal (PL-RS) for the positioning signal transmission based on a PL-RS reference for each cell of a plurality of cells in the cell group.

Aspect 71 is the method of any of aspects 62 to 70, where the configuration for the positioning signal transmission may include a third indication to calculate a spatial relationship for the positioning signal transmission based on a first spatial relationship reference of a first cell in the cell group.

Aspect 72 is the method of aspect 71, where the first spatial relationship reference may include at least one of an SSB, a channel state information (CSI) reference signal (CSI-RS), a positioning reference signal (PRS), a sounding reference signal (SRS), a resource of a first SRS in the set of positioning signals, a resource position of a second SRS in the set of positioning signals, or a bandwidth part (BWP).

Aspect 73 is the method of any of aspects 62 to 72, where the configuration for the positioning signal transmission may include a third indication to calculate a spatial relationship for the positioning signal transmission based on a spatial relationship reference for each of a plurality of cells in the cell group.

Aspect 74 is the method of any of aspects 62 to 73, where the method may include outputting downlink control information (DCI) or a medium access control (MAC) control element (MAC-CE) to the UE via a cell in the cell group. The DCI or the MAC-CE may include a third indication to transmit the positioning signal transmission.

Aspect 75 is the method of aspect 74, where transmitting the configuration for the positioning signal transmission may include transmitting a radio resource control (RRC) configuration including the configuration for the positioning signal transmission.

Aspect 76 is the method of any of aspects 62 to 75, where the method may include outputting DCI or a MAC-CE to the UE via each cell of a plurality of cells in the cell group. Each of the DCI or each of the MAC-CE may include an indication to transmit the SRS transmission.

Aspect 77 is the method of any of aspects 62 to 76, where the configuration for the positioning signal transmission may include a third indication to calculate a timing for the positioning signal transmission based on a first timing of a first positioning signal in the set of positioning signals.

Aspect 78 is the method of any of aspects 62 to 77, where the configuration for the positioning signal transmission may include a third indication to calculate a timing for the positioning signal transmission based on a timing of each positioning signal of a plurality of positioning signals in the set of positioning signals.

Aspect 79 is the method of any of aspects 62 to 78, where the positioning signal transmission may include a sounding reference signal (SRS) transmission. The set of positioning signals may include a set of SRSs.

Aspect 80 is the method of any of aspects 62 to 79, where the configuration may include a third indication to periodically transmit the positioning signal transmission according to a schedule.

Aspect 81 is an apparatus for wireless communication, including: a memory; and at least one processor coupled to the memory and, based at least in part on information stored in the memory, the at least one processor is configured to implement any of aspects 44 to 80.

Aspect 82 is the apparatus of aspect 81, further including at least one of an antenna or a transceiver coupled to the at least one processor.

Aspect 83 is an apparatus for wireless communication including means for implementing any of aspects 44 to 80.

Aspect 84 is a computer-readable medium (e.g., a non-transitory computer-readable medium) storing computer executable code, where the code when executed by a processor causes the processor to implement any of aspects 44 to 80.

What is claimed is:

1. An apparatus for wireless communication at a user equipment (UE), comprising:
a memory; and
at least one processor coupled to the memory and, based at least in part on information stored in the memory, the at least one processor is configured to:
receive a configuration for a positioning signal transmission from a network entity, wherein the configuration includes a first indication of a cell group associated with a set of positioning signals or a second indication of at least one transmission gap associated with the set of positioning signals, wherein the cell group includes a plurality of cells, wherein the at least one transmission gap corresponds with at least one transmission period of the set of positioning signals; and
transmit the positioning signal transmission based on at least one of the cell group or the at least one transmission gap, wherein the positioning signal transmission includes the set of positioning signals.

2. The apparatus of claim 1, further comprising a transceiver coupled to the at least one processor, wherein, to transmit the positioning signal transmission, the at least one processor is configured to:
transmit, via the transceiver, the positioning signal transmission during the at least one transmission gap, wherein, during the at least one transmission gap, the cell group is not associated with any uplink (UL) or downlink (DL) transmissions other than the set of positioning signals.

3. The apparatus of claim 1, wherein the configuration further includes a list of resource sets, wherein each resource set in the list of resource sets is associated with a plurality of positioning signal resources.

4. The apparatus of claim 1, wherein the configuration for the positioning signal transmission is associated with a radio resource control (RRC) inactive state, wherein the at least one processor is further configured to:
enter the RRC inactive state, wherein, to transmit the positioning signal transmission, the at least one processor is configured to transmit the positioning signal transmission during the RRC inactive state.

5. The apparatus of claim 1, wherein the configuration comprises an indication of a first sub-carrier spacing (SCS) associated with the positioning signal transmission, wherein the first SCS is different from a second SCS of a first cell in the cell group.

6. The apparatus of claim 1, wherein the at least one processor is further configured to:
calculate a pathloss reference signal (PL-RS) for the positioning signal transmission based on a first PL-RS reference of a first cell in the cell group, wherein, to transmit the positioning signal transmission, the at least one processor is configured to transmit the positioning signal transmission based on the calculated PL-RS.

7. The apparatus of claim 6, wherein the first PL-RS reference comprises at least one of a synchronization signal block (SSB) or a downlink positioning reference signal (DL-PRS) of the first cell in the cell group.

8. The apparatus of claim 1, wherein the at least one processor is further configured to:
calculate a pathloss reference signal (PL-RS) for the positioning signal transmission based on a PL-RS reference for each cell of the plurality of cells in the cell group, wherein, to transmit the positioning signal transmission, the at least one processor is configured to transmit the positioning signal transmission based on the calculated PL-RS.

9. The apparatus of claim 1, wherein the at least one processor is further configured to:
calculate a spatial relationship for the positioning signal transmission based on a first spatial relationship reference of a first cell in the cell group, wherein, to transmit the positioning signal transmission, the at least one processor is configured to transmit the positioning signal transmission based on the calculated spatial relationship.

10. The apparatus of claim 9, wherein the first spatial relationship reference comprises at least one of a synchronization signal block (SSB), a channel state information (CSI) reference signal (CSI-RS), a positioning reference signal (PRS), a sounding reference signal (SRS), a resource of a first SRS in the set of positioning signals, a resource position of a second SRS in the set of positioning signals, or a bandwidth part (BWP).

11. The apparatus of claim 1, wherein the at least one processor is further configured to:
calculate a spatial relationship for the positioning signal transmission based on a spatial relationship reference for each of the plurality of cells in the cell group, wherein, to transmit the positioning signal transmission, the at least one processor is configured to transmit the positioning signal transmission based on the calculated spatial relationship.

12. The apparatus of claim 1, wherein the at least one processor is further configured to:
receive downlink control information (DCI) or a medium access control (MAC) control element (MAC-CE) from a cell in the cell group, wherein the DCI or the MAC-CE comprises a third indication to transmit the positioning signal transmission, wherein, to transmit the positioning signal transmission, the at least one processor is configured to transmit the positioning signal transmission in response to the reception of the third indication from the cell in the cell group.

13. The apparatus of claim 12, wherein, to receive the configuration for the positioning signal transmission, the at least one processor is configured to:
receive a radio resource control (RRC) configuration comprising the configuration for the positioning signal transmission.

14. The apparatus of claim 1, wherein the at least one processor is further configured to:
receive downlink control information (DCI) or a medium access control (MAC) control element (MAC-CE) from each cell of the plurality of cells in the cell group, wherein the DCI or the MAC-CE comprises a third indication to transmit the positioning signal transmission, wherein, to transmit the positioning signal transmission, the at least one processor is configured to transmit the positioning signal transmission in response to the reception of the third indication from each cell of the plurality of cells in the cell group.

15. The apparatus of claim 1, wherein the at least one processor is further configured to:
calculate a timing for the positioning signal transmission based on a first timing of a first positioning signal in the set of positioning signals, wherein, to transmit the positioning signal transmission, the at least one processor is configured to transmit the positioning signal transmission based on the calculated timing.

16. The apparatus of claim 1, wherein the at least one processor is further configured to:
calculate a timing for the positioning signal transmission based on a reference timing of each positioning signal of a plurality of positioning signals in the set of positioning signals, wherein, to transmit the positioning signal transmission, the at least one processor is configured to transmit the positioning signal transmission based on the calculated timing.

17. The apparatus of claim 1, wherein the positioning signal transmission comprises a sounding reference signal (SRS) transmission, wherein the set of positioning signals comprises a set of SRSs.

18. The apparatus of claim 1, wherein the configuration comprises a third indication to periodically transmit the positioning signal transmission according to a schedule.

19. An apparatus for wireless communication at a network entity, comprising:
a memory; and
at least one processor coupled to the memory and, based at least in part on information stored in the memory, the at least one processor is configured to:
transmit a configuration for a positioning signal transmission to a user equipment (UE), wherein the configuration includes a first indication of a cell group for a set of positioning signals or a second indication of at least one transmission gap associated with the set of positioning signals, wherein the cell group includes a plurality cells, wherein the at least one transmission gap corresponds with at least one transmission period of the set of positioning signals; and
receive the positioning signal transmission from the UE based on at least one of the cell group for the set of positioning signals or the at least one transmission gap associated with the set of positioning signals, wherein the positioning signal transmission includes the set of positioning signals.

20. The apparatus of claim 19, further comprising a transceiver coupled to the at least one processor, wherein, to receive the positioning signal transmission, the at least one processor is configured to:
receive, via the transceiver, the positioning signal transmission during the at least one transmission gap, and wherein, during the at least one transmission gap, the cell group is not associated with any uplink (UL) or downlink (DL) transmissions with the UE other than the set of positioning signals.

21. The apparatus of claim 19, wherein the configuration for the positioning signal transmission is associated with a radio resource control (RRC) inactive state, wherein, to receive the positioning signal transmission, the at least one processor is configured to:
receive the positioning signal transmission during the RRC inactive state of the UE.

22. The apparatus of claim 19, wherein the configuration for the positioning signal transmission comprises a third indication to calculate a spatial relationship for the positioning signal transmission based on a first spatial relationship reference of a first cell in the cell group.

23. The apparatus of claim 22, wherein the first spatial relationship reference comprises at least one of an SSB, a channel state information (CSI) reference signal (CSI-RS), a positioning reference signal (PRS), a sounding reference signal (SRS), a resource of a first SRS in the set of positioning signals, a resource position of a second SRS in the set of positioning signals, or a bandwidth part (BWP).

24. The apparatus of claim 19, wherein the configuration for the positioning signal transmission comprises a third indication to calculate a spatial relationship for the positioning signal transmission based on a spatial relationship reference for each of a plurality of cells in the cell group.

25. The apparatus of claim 19, wherein the at least one processor is further configured to:
output downlink control information (DCI) or a medium access control (MAC) control element (MAC-CE) to the UE via a cell in the cell group, wherein the DCI or the MAC-CE comprises a third indication to transmit the positioning signal transmission.

26. The apparatus of claim 25, wherein, to transmit the configuration for the positioning signal transmission, the at least one processor is configured to:
transmit a radio resource control (RRC) configuration comprising the configuration for the positioning signal transmission.

27. The apparatus of claim 19, wherein the positioning signal transmission comprises a sounding reference signal (SRS) transmission, wherein the set of positioning signals comprises a set of SRSs.

28. The apparatus of claim 19, wherein the configuration comprises a third indication to periodically transmit the positioning signal transmission according to a schedule.

29. A method of wireless communication at a user equipment (UE), comprising:
receiving a configuration for a positioning signal transmission from a network entity, wherein the configuration includes a first indication of a cell group associated with a set of positioning signals or a second indication of at least one transmission gap associated with the set of positioning signals, wherein the cell group includes a plurality of cells, wherein the at least one transmission gap corresponds to at least one transmission period of the set of positioning signals; and
transmitting the positioning signal transmission based on at least one of the cell group or the at least one transmission gap, wherein the positioning signal transmission includes the set of positioning signals.

30. A method of wireless communication at a network entity, comprising:
transmitting a configuration for a positioning signal transmission to a user equipment (UE), wherein the configuration includes a first indication of a cell group for a set of positioning signals or a second indication of at least one transmission gap associated with the set of positioning signals, wherein the cell group includes a plurality cells, wherein the at least one transmission gap corresponds to at least one transmission period of the set of positioning signals; and
receiving the positioning signal transmission from the UE based on at least one of the cell group for the set of positioning signals or the at least one transmission gap associated with the set of positioning signals, wherein the positioning signal transmission includes the set of positioning signals.
